(19) United States
(12) Patent Application Publication
(10) Pub. No.: US 2015/0317014 A1
(43) Pub. Date: Nov. 5, 2015

(54) Semiconductor Device, Touch Sensor, and Display Device

(71) Applicant: Semiconductor Energy Laboratory Co., Ltd., Kanagawa-ken (JP)

(72) Inventors: Hiroyuki MIYAKE, Atsugi (JP); Kenichi OKAZAKI, Tochigi (JP); Junichi KOEZUKA, Tochigi (JP); Masami JINTYOU, Shimotsuga (JP); Takashi HAMOCHI, Tochigi (JP)

(73) Assignee: Semiconductor Energy Laboratory Co., Ltd., Kanagawa-ken (JP)

(21) Appl. No.: 14/699,728

(22) Filed: Apr. 29, 2015

(30) Foreign Application Priority Data
May 2, 2014 (JP) 2014-095101

(51) Int. Cl. G06F 3/047; G09G 5/00; G06F 3/044

(52) U.S. Cl. CPC G06F 3/047; G06F 3/044; G09G 5/003; G09G 2300/04

(57) ABSTRACT

A wiring is inhibited from being visible. Alternatively, a display device or a touch panel with high viewability is provided. A semiconductor device includes a transistor and a wiring electrically connected to the transistor that are over a light-transmitting substrate. Furthermore, a layer including an oxide semiconductor is provided closer to a substrate side than the wiring is so as to overlap with the wiring and serve as an anti-reflection layer that suppress light reflection at the wiring.

### BACKGROUND OF THE INVENTION

1. Field of the Invention

One embodiment of the present invention relates to a semiconductor device. Another embodiment of the present invention relates to a touch sensor. The present invention relates to a display device.

In this specification and the like, a semiconductor device generally means a device that can function by utilizing semiconductor characteristics. A semiconductor element such as a transistor, a semiconductor circuit, an arithmetic device, and a memory device are each an embodiment of a semiconductor device. An imaging device, a display device, a liquid crystal display device, a light-emitting device, an electro-optical device, a power generation device (including a thin film solar cell, an organic thin film solar cell, and the like), and an electronic device may each include a semiconductor device.

Note that one embodiment of the present invention is not limited to the above technical field. One embodiment of the invention disclosed in this specification and the like relates to an object, a method, or a manufacturing method. One embodiment of the present invention relates to a process, a machine, manufacture, or a composition of matter. Specifically, examples of the technical field of one embodiment of the present invention disclosed in this specification include a semiconductor device, a display device, a light-emitting device, a power storage device, a memory device, an electronic device, a lighting device, an input device, an input/output device, a method for driving any of them, and a method for manufacturing any of them.

2. Description of the Related Art

A technique in which a transistor is formed using a semiconductor material has attracted attention. The transistor is used in a wide range of electronic devices such as an integrated circuit (IC) or an image display device (also simply referred to as a display device). As semiconductor materials usable for the transistor, silicon-based semiconductor materials have been widely used, but oxide semiconductors have been attracting attention as alternative materials in recent years.

For example, a technique for formation of a transistor using zinc oxide or an In—Ga—Zn-based oxide semiconductor as an oxide semiconductor is disclosed (see Patent Documents 1 and 2).

Recent display devices are expected to be applied to a variety of uses and become diversified. For example, a smartphone, a tablet, and the like with a touch panel are being developed as portable information appliances.

### REFERENCE

### Patent Document

### [Patent Document 1] Japanese Published Patent Application No. 2007-123861

### [Patent Document 2] Japanese Published Patent Application No. 2007-096055

### SUMMARY OF THE INVENTION

A display device with improved viewability has been desired.

There is a problem in that viewability of an image on a display device is decreased because of visible wirings and the like included in the display device. For example, if a light-reflective material is used for wirings and the like included in a display device, the wirings may be visible when a display surface of the display device is exposed to intense light from outside.

One object of one embodiment of the present invention is to inhibit wirings from being visible. Another object is to provide a display device or a touch panel with excellent viewability. Another object is to provide a semiconductor device, a display device, a touch sensor, or a touch panel with high reliability. Another object is to provide a novel input device. Another object is to provide a novel input/output device.

Note that the descriptions of these objects do not disturb the existence of other objects. In one embodiment of the present invention, there is no need to achieve all the objects. Other objects will be apparent from and can be derived from the description of the specification, the drawings, the claims, and the like.

One embodiment of the present invention is a semiconductor device including a transistor, a wiring, and a first layer that are over a substrate. The substrate transmits visible light. The transistor includes a gate electrode, a semiconductor layer, a first electrode, and a second electrode. The wiring is electrically connected to the gate electrode, the first electrode, or the second electrode. The first layer is positioned closer to the substrate than the wiring is. The first layer and the wiring overlap with each other in a region. The first layer includes an oxide semiconductor.

Furthermore, the semiconductor layer preferably includes an oxide semiconductor.

The first layer preferably includes a region in which transmittance with respect to light with a certain wavelength within a range of 400 nm to 750 nm is lower than in the semiconductor layer.

In addition, the first layer preferably includes a region with conductivity higher than that of the semiconductor layer.

Another embodiment of the present invention is a touch sensor including the semiconductor device and a capacitor electrically connected to the transistor.

Another embodiment of the present invention is a touch panel including the touch sensor and a display panel.

Another embodiment of the present invention is a display device including a display element electrically connected to the transistor. Here, the display element preferably includes a light-emitting element, and the light-emitting element preferably has a function of emitting light to the substrate side.

It is preferable to form a touch panel module by combining the tough panel and a flexible printed circuit (FPC). It is preferable to form a display panel module by combining the display device and an FPC. An electronic device where the touch panel module or the display panel module is embedded in a housing is also one embodiment of the present invention.

According to one embodiment of the present invention, wirings can be inhibited from being visible. Alternatively, a display device or a touch panel with excellent viewability can be provided. Alternatively, a semiconductor device, a display device, a touch sensor, or a touch panel with high reliability can be provided. Alternatively, a novel input device can be provided. Alternatively, a novel input/output device can be provided. Note that the description of these effects does not disturb the existence of other effects. One embodiment of the present invention does not necessarily achieve all the effects listed above. Other effects will be apparent from and can be derived from the description of the specification, the drawings, the claims, and the like.

### BRIEF DESCRIPTION OF THE DRAWINGS

In the accompanying drawings:

FIGS. 1A and 1B illustrate a structure example of a semiconductor device of Embodiment;

FIGS. 2A to 2E illustrate an example of a method for manufacturing a semiconductor device of Embodiment;

FIGS. 3A and 3B illustrate an example of a method for manufacturing a semiconductor device of Embodiment;

FIGS. 4A to 4C illustrate an example of a method for manufacturing a semiconductor device of Embodiment;

FIGS. 5A and 5B illustrate an example of a method for manufacturing a semiconductor device of Embodiment;

FIGS. 6A and 6B illustrate a structure example of a touch panel module of Embodiment;

FIGS. 7A and 7B illustrate a structure example of a touch panel module of Embodiment;

FIGS. 8A and 8B illustrate a structure example of a touch panel module of Embodiment;

FIG. 9 illustrates a structure example of a touch panel module of Embodiment;

FIG. 10 illustrates a structure example of a display device of Embodiment;

FIGS. 11A, 11B, 11C, 11D1; and 11D2 are a block diagram, circuit diagrams, and timing charts of a touch panel of Embodiment;

FIGS. 12A to 12C are a circuit diagram and schematic diagrams of a structure in a touch panel of Embodiment;

FIGS. 13A to 13C are a block diagram and circuit diagrams of a structure in a touch panel of Embodiment;

FIGS. 14A to 14C are circuit diagrams of a structure in a touch panel of Embodiment;

FIG. 15 illustrates a driving method of a touch panel of Embodiment;

FIGS. 16A to 16G each illustrate an electronic device of Embodiment;

FIGS. 17A to 17I each illustrate an electronic device of Embodiment;

FIG. 18 shows measurement results of transmittance in Example.

### DETAILED DESCRIPTION OF THE INVENTION

Embodiments will be described in detail with reference to drawings. Note that the present invention is not limited to the description below, and it is easily understood by those skilled in the art that various changes and modifications can be made without departing from the spirit and scope of the present invention. Accordingly, the present invention should not be interpreted as being limited to the content of the embodiments below.

Note that in the structures of the invention described below, the same portions or portions having similar functions are denoted by the same reference numerals in different drawings, and description of such portions is not repeated. Further, the same hatching pattern is applied to portions having similar functions, and the portions are not especially denoted by reference numerals in some cases.

Note that in each drawing described in this specification, the size, the layer thickness, or the region of each component is exaggerated for clarity in some cases. Therefore, embodiments of the present invention are not limited to such a scale.

Note that in this specification and the like, ordinal numbers such as “first”, “second”, and the like are used in order to avoid confusion among components and do not limit the number.

A transistor is a kind of semiconductor elements and can achieve amplification of current or voltage, switching operation for controlling conduction or non-conduction, or the like. A transistor in this specification may be an insulated-gate field effect transistor (IGFET) or a thin film transistor (TFT).

Note that the terms “film” and “layer” can be interchanged with each other depending on the case or circumstances. For example, the term “conductive layer” can be changed into the term “conductive film” in some cases. Also, the term “insulating film” can be changed into the term “insulating layer” in some cases.

### Embodiment 1

A semiconductor device of one embodiment of the present invention includes a transistor and a wiring electrically connected to the transistor that are over a light-transmitting substrate. Furthermore, a layer including an oxide semiconductor is positioned closer to the substrate than the wiring is, overlapping with the wiring. Such a structure can suppress light reflection at the wiring.

Such a structure can be used for, for example, a display device displaying an image, a touch sensor sensing contact or proximity of an object, a display device having a function as a touch sensor (also referred to as a touch panel), and the like, and can inhibit a wiring put on the viewer side from reflecting light to be visible.

The transmittance of the layer including the oxide semiconductor and provided to overlap with the wiring can be lowered by performing a certain treatment on the layer. Providing such a layer including an oxide semiconductor closer to a viewer than the wiring is can increase an effect of suppressing reflection of outside light. Compared to a layer including an oxide semiconductor that is not subjected to the certain treatment (e.g., a semiconductor layer in which a channel of a transistor is formed), the layer including the oxide semiconductor on which the certain treatment has been performed has low transmittance with respect to light with a certain wavelength in a range of visible light (e.g., light with a wavelength within a range of 400 nm to 750 nm). This is because the oxide semiconductor which has been subjected to the certain treatment easily absorbs light with a certain wavelength.

In some cases, the layer including the oxide semiconductor which has been subjected to the certain treatment has higher conductivity than a layer that is not subjected to the certain treatment. Therefore, when the layer including the oxide semiconductor which has been subjected to the certain treatment was provided to be in contact with the wiring, the layer can serve as part of the wiring.

As the certain treatment, treatment which changes optical absorption characteristics of an oxide semiconductor such as plasma treatment, impurity introduction treatment, or heat treatment can be used. Such treatment can cause change of a structure or composition of the oxide semiconductor, introduction of impurity to the oxide semiconductor, reforming of the film surface, or the like. As a result, a band structure of the oxide semiconductor is changed by these factors, which facilitates light absorption. That is, the oxide semiconductor that has been subjected to such treatment has a marked effect of absorbing light with a certain wavelength than that not subjected to the treatment.

A layer including an oxide semiconductor that is provided to overlap with a wiring is sometimes referred to as a first layer or an anti-reflection layer below.

Specific structure examples and manufacturing method examples of one embodiment of the present invention are described below with reference to drawings.

### Structure Example

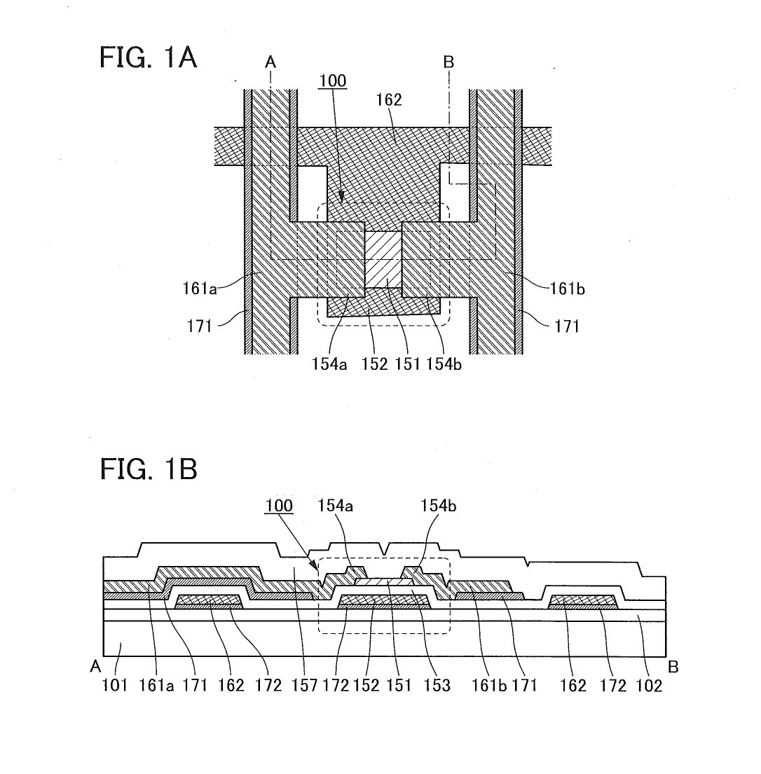

FIG. 1A is a schematic top view of a semiconductor device of one embodiment of the present invention. FIG. 1B is a schematic cross-sectional view taken along A-B line in FIG. 1A. Note that some components are not illustrated in FIG. 1A for clarity.

The semiconductor device includes a transistor 100, a wiring 161a, a wiring 161b, and a wiring 162 that are over a substrate 101.

The transistor 100 includes a gate electrode 152, an insulating layer 153, a semiconductor layer 151, an electrode 154a, and an electrode 154b. The wiring 161a is electrically connected to the electrode 154a. The wiring 161b is electrically connected to the electrode 154b. The wiring 162 is electrically connected the gate electrode 152. The electrode 154a serves as one of a source and a drain of the transistor 100. The electrode 154b serves as the other of the source and the drain of the transistor 100.

Here, part of the wiring 162 serves as the gate electrode 152. Similarly, part of the wiring 161a and part of the wiring 161b serve as the electrode 154a and the electrode 154b, respectively. For example, in the wiring 162, a portion in the vicinity of the semiconductor layer 151, a portion having a function of applying an electric field to the semiconductor layer 151, or a portion overlapping with the semiconductor layer 151 can be referred to as the gate electrode 152. In addition, in the wiring 161a or 161b, a portion in the vicinity of the semiconductor layer 151, a portion having a function of applying an electric field to the semiconductor layer 151, or a portion overlapping with the semiconductor layer 151 can be referred to as the electrode 154a or the electrode 154b.

Anti-reflection layers 171 are in contact with the bottom surfaces of the wiring 161a and the wiring 161b. The anti-reflection layer 171 is not provided under a portion of the wiring 161a serving as the electrode 154a and a portion of the wiring 161b serving as the electrode 154b. In other words, the anti-reflection layer 171 is not in contact with the semiconductor layer 151.

An anti-reflection layer 172 is in contact with the bottom surface of the wiring 162. As shown in FIG. 1B, the anti-reflection layer 172 may be provided to overlap also with a portion of the wiring 162 serving as the gate electrode 152.

For the anti-reflection layers 171 and 172, a material with reflectivity lower than that of the wirings 161a, 161b, and 162 can be used. The anti-reflection layer 172 preferably includes an oxide semiconductor.

It is preferable that the anti-reflection layers 171 and 172 have been subjected to appropriate treatment for lowering the transmittance. When the anti-reflection layers 171 and 172 each include an oxide semiconductor, for example, transmittance thereof can be greatly lowered by performing appropriate treatment on the oxide semiconductor; thus, light reflection at the wirings 161a, 161b, and 162 can be effectively suppressed.

Most preferably, the anti-reflection layers 171 and 172 have a black body; however, a material which absorbs light with a certain wavelength in the range of visible light (e.g., light with a wavelength in a range of 400 nm to 750 nm) can be favorably used. At that time, when incident light is white, the light that has passed through the anti-reflection layer 171 or 172 is colored because the intensity of light with a certain wavelength is decreased. When incident light from the outside is reflected at the bottom surface of the wiring, for example, the incident light passes through the anti-reflection layer 171 or 172 twice and then go to the outside. Here, the reflected light is colored rather than white and the light intensity is greatly decreased compared to that of the incident light. Therefore, even when a display surface of the device is exposed to intense outside light, the wiring is not easily visible.

For the anti-reflection layers 171 and 172, a material with transmittance lower than the semiconductor layer 151 is preferably used. Alternatively, for the anti-reflection layers 171 and 172, a material whose light absorptance with respect to light with a certain wavelength is higher than that of than the semiconductor layer 151 is preferably used. For example, a material that has higher transmittance with respect to light with a certain wavelength in the range of visible light (e.g., light with a wavelength in a range of 400 nm to 750 nm) than the semiconductor layer 151 is preferably used.

The anti-reflection layers 171 and 172 preferably have higher conductivity than the semiconductor layer 151. By being in contact with the bottom surface of the wiring 161a, 161b, or 162, the anti-reflection layer 171 or 172 can serve as part of the wiring. As a result, the conductivity of each wiring can be increased, whereby signal delay or the like can be suppressed.

The anti-reflection layers 171 and 172 preferably include the same material as the semiconductor layer 151. Formation of these layers with the same material can reduce manufacturing cost because the same manufacturing apparatus can be used. In addition, it is preferable to form the anti-reflection layer 172 and the semiconductor layer 151 at the same time by processing the same semiconductor film for simplification of the manufacturing steps.

As a material for the anti-reflection layers 171 and 172, an oxide including at least indium (In) or zinc (Zn) is preferably used, for example. More preferably, an In-M-Zn-based oxide (M is a metal such as Al, Ti, Ga, Ge, Y, Zr, Sn, La, Ce, or Hf) is used.

As a material for the anti-reflection layers 171 and 172, other than an oxide semiconductor, a material including a conductive oxide, a conductive organic compound, or an organic semiconductor may be used.

Note that although the transistor 100 in FIGS. 1A and 1B has a bottom gate structure, the structure of the transistor 100 is not limited thereto, and may be a top gate structure. At that time, an anti-reflection layer is provided to overlap with a wiring electrically connected to the gate electrode, the source electrode or the drain electrode of the transistor.

The above is the description of a structure example.

### [Components]

Other components of the semiconductor device of this embodiment are described below in detail.

### <Substrate>

There is no particular limitation on the property of a material and the like of the substrate 101 as long as the material has heat resistance enough to withstand at least heat treatment to be performed later. For example, a glass substrate, a ceramic substrate, a quartz substrate, a sapphire substrate, or the like may be used as the substrate 101. Alternatively, a single crystal semiconductor substrate or a polycrystalline semiconductor substrate made of silicon, silicon carbide, or the like, a compound semiconductor substrate made of silicon germanium or the like, an SOI substrate, or the like may be used as the substrate 101. Furthermore, any of these substrates further provided with a semiconductor element may be used as the substrate 101. In the case where a glass substrate is used as the substrate 101, a glass substrate having any of the following sizes and the like can be used: the 6th generation (1500 mm×1850 mm), the 7th generation (1870 mm×2200 mm), the 8th generation (2200 mm×2400 mm), the 9th generation (2400 mm×2800 mm), and the 10th generation (2950 mm×3400 mm). Thus, a large-sized display device can be manufactured.

Alternatively, a flexible substrate may be used as the substrate 101, and the transistor 100 may be provided directly on the flexible substrate. Further alternatively, a separation layer may be provided between the substrate 101 and the transistor 100. The separation layer can be used when part or the whole of a semiconductor device formed over the separation layer is separated from the substrate 101 and transferred onto another substrate. In such a case, the transistor 100 can be transferred to a substrate having low heat resistance or a flexible substrate as well.

### <Conductive Film>

The gate electrode, the source electrode, the drain electrode, and wirings can be formed using a metal element selected from chromium, copper, aluminum, gold, silver, zinc, molybdenum, tantalum, titanium, tungsten, manganese, nickel, iron, cobalt, yttrium, and zirconium; an alloy containing any of these metal elements as its component; an alloy containing a combination of any of these metal elements; or the like.

The conductive film may have a single-layer structure or a stacked-layer structure of two or more layers. For example, a single-layer structure of an aluminum film containing silicon, a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure in which a titanium film, an aluminum film, and a titanium film are stacked in this order, and the like can be given. Alternatively, an alloy film or a nitride film which contains aluminum and one or more elements selected from titanium, tantalum, tungsten, molybdenum, chromium, neodymium, and scandium may be used.

The conductive film can be formed using a light-transmitting conductive material such as indium tin oxide, indium oxide containing tungsten oxide, indium zinc oxide containing tungsten oxide, indium oxide containing titanium oxide, indium tin oxide containing titanium oxide, indium zinc oxide, or indium tin oxide to which silicon oxide is added.

A Cu—X alloy film (X is Mn, Ni, Cr, Fe, Co, Mo, Ta, or Ti) may be used for the conductive film. Use of a Cu—X alloy film enables the manufacturing cost to be reduced because wet etching process can be used in the processing.

### <Gate Insulating Layer>

As the insulating layer 153 serving as a gate insulating layer of the transistor 100, an insulating layer including at least one of the following films formed by a plasma enhanced chemical vapor deposition (PECVD) method, a sputtering method, or the like can be used: a silicon oxide film, a silicon oxynitride film, a silicon nitride oxide film, a silicon nitride film, an aluminum oxide film, a hafnium oxide film, an yttrium oxide film, a zirconium oxide film, a gallium oxide film, a tantalum oxide film, a magnesium oxide film, a lanthanum oxide film, a cerium oxide film, and a neodymium oxide film. Note that the insulating layer 153 may have a single-layer structure or a stacked-layer structure with two or more layers, using any of the above-mentioned insulating films.

Note that the insulating layer 153 that is in contact with the semiconductor layer 151 serving as a channel region of the transistor 100 is preferably an oxide insulating film and preferably includes a region including oxygen in excess of the stoichiometric composition (oxygen-excess region). In other words, the insulating layer 153 is an insulating film from which oxygen can be released. In order to provide the oxygen-excess region in the insulating layer 153, the insulating layer 153 may be formed in an oxygen atmosphere, for example. Alternatively, oxygen may be introduced into the formed insulating layer 153 to provide the oxygen-excess region therein. As a method for introducing oxygen, an ion implantation method, an ion doping method, a plasma immersion ion implantation method, plasma treatment, or the like may be employed.

Using hafnium oxide for the insulating layer 153 has the following effects. Hafnium oxide has a higher dielectric constant than silicon oxide and silicon oxynitride. Therefore, in the case where hafnium oxide is used for the insulating layer 153, the thickness of the insulating layer 153 can be made large as compared with the case where silicon oxide is used for the insulating layer 153; thus, leakage current due to tunnel current can be low. That is, it is possible to provide a transistor with a low off-state current. Moreover, hafnium oxide with a crystalline structure has higher dielectric constant than hafnium oxide with an amorphous structure. Therefore, it is preferable to use hafnium oxide with a crystalline structure in order to provide a transistor with a low off-state current. Examples of the crystalline structure include a monoclinic crystal structure and a cubic crystal structure. Note that one embodiment of the present invention is not limited to the above examples.

### <Semiconductor Film>

An oxide semiconductor film is preferably used for the semiconductor layer 151, the anti-reflection layer 171, and the anti-reflection layer 172. The oxide semiconductor film contains, for example, In, Zn, or M (M is Mg, Al, Ti, Ga, Y, Zr, Sn, La, Ce, Nd, or Hf) as well as oxygen. Typically, an In—Ga oxide, an In—Zn oxide, or an In-M-Zn oxide can be used for the oxide semiconductor film. It is particularly preferable to use an In-M-Zn oxide as the oxide semiconductor film.

In the case where the oxide semiconductor film is an In-M-Zn oxide, it is preferable that the atomic ratio of metal elements of a sputtering target used for forming a film of the In-M-Zn oxide satisfy In≧M and Zn≧M. As the atomic ratio of metal elements of such a sputtering target, In:M:Zn=1:1:1, In:M:Zn=1:1:1.2, In:M:Zn=3:1:2, and In:M:Zn=4:2:4.1 are preferable. When the oxide semiconductor film is an In-M-Zn oxide, a target including polycrystalline In-M-Zn oxide is preferably used as a sputtering target. With the use of the target including polycrystalline In-M-Zn oxide, an oxide semiconductor film having crystallinity can be easily formed. Note that the atomic ratio of metal elements in the oxide semiconductor film varies from the atomic ratio of those in the above-described sputtering target, within a range of ±40% as an error.

Note that in the case where the oxide semiconductor film is an In-M-Zn oxide film, the proportion of In and the proportion of M, not taking Zn and O into consideration, are preferably greater than 25 atomic % and less than 75 atomic %, respectively, or further preferably greater than 34 atomic % and less than 66 atomic %, respectively.

The energy gap of the oxide semiconductor film is 2 eV or more, preferably 2.5 eV or more, further preferably 3 eV or more. In this manner, the off-state current of the transistor 100 can be reduced by using an oxide semiconductor having a wide energy gap.

The thickness of the oxide semiconductor film is greater than or equal to 3 nm and less than or equal to 200 nm, preferably greater than or equal to 3 nm and less than or equal to 100 nm, further preferably greater than or equal to 3 nm and less than or equal to 50 nm.

An oxide semiconductor film with low carrier density is used as the semiconductor film. For example, the carrier density of the oxide semiconductor film is lower than or equal to 1×10¹⁷/cm³, preferably lower than or equal to 1×10¹⁵/cm³, further preferably lower than or equal to 1×10¹³/cm³, still further preferably lower than or equal to 1×10¹¹/cm³.

Note that, without limitation to those described above, a material with an appropriate composition may be used depending on required semiconductor characteristics and electrical characteristics (e.g., field-effect mobility and threshold voltage) of a transistor. To obtain the required semiconductor characteristics of the transistor, it is preferable that the carrier density, the impurity concentration, the defect density, the atomic ratio between a metal element and oxygen, the interatomic distance, the density, and the like of the oxide semiconductor film be set to appropriate values.

Note that it is preferable to use, as the oxide semiconductor film, an oxide semiconductor film in which the impurity concentration is low and density of defect states is low, in which case the transistors can have more excellent electrical characteristics. Here, the state in which impurity concentration is low and density of defect states is low (the number of oxygen vacancies is small) is referred to as “highly purified intrinsic” or “substantially highly purified intrinsic”. A highly purified intrinsic or substantially highly purified intrinsic oxide semiconductor film has few carrier generation sources, and thus can have a low carrier density. Thus, a transistor in which a channel region is formed in the oxide semiconductor film rarely has a negative threshold voltage (is rarely normally on). A highly purified intrinsic or substantially highly purified intrinsic oxide semiconductor film has a low density of defect states and accordingly has a low density of trap states in some cases. Further, the highly purified intrinsic or substantially highly purified intrinsic oxide semiconductor film has an extremely low off-state current; even when an element has a channel width (W) of 1×10⁶ tan and a channel length (L) of 10 μm, the off-state current can be less than or equal to the measurement limit of a semiconductor parameter analyzer, i.e., less than or equal to 1×10⁻¹³ A, at a voltage (drain voltage) between a source electrode and a drain electrode of from 1 V to 10 V.

Accordingly, the transistor in which the channel region is formed in the highly purified intrinsic or substantially highly purified intrinsic oxide semiconductor film can have a small variation in electrical characteristics and high reliability. Charges trapped by the trap states in the oxide semiconductor film take a long time to be released and may behave like fixed charges. Thus, the transistor whose channel region is formed in the oxide semiconductor film having a high density of trap states has unstable electrical characteristics in some cases. As examples of the impurities, hydrogen, nitrogen, alkali metal, alkaline earth metal, and the like are given.

Hydrogen contained in the oxide semiconductor film reacts with oxygen bonded to a metal atom to be water, and also causes oxygen vacancies in a lattice from which oxygen is released (or a portion from which oxygen is released). Due to entry of hydrogen into the oxygen vacancy, an electron serving as a carrier is generated in some cases. Furthermore, in some cases, bonding of part of hydrogen to oxygen bonded to a metal element causes generation of an electron serving as a carrier. Thus, a transistor including an oxide semiconductor film which contains hydrogen is likely to be normally on. Accordingly, it is preferable that hydrogen be reduced as much as possible in the oxide semiconductor film. Specifically, in the oxide semiconductor film, the concentration of hydrogen which is measured by secondary mass spectrometry (SIMS) is lower than or equal to 2×10²⁰ atoms/cm³, preferably lower than or equal to 5×10¹⁹ atoms/cm³, further preferably lower than or equal to 1×10¹⁹ atoms/cm³, further preferably lower than or equal to 5×10¹⁸ atoms/cm³, further preferably lower than or equal to 1×10¹⁸ atoms/cm³, further preferably lower than or equal to 5×10¹⁷ atoms/cm³, or further preferably lower than or equal to 1×10¹⁶ atoms/cm³.

When silicon or carbon that is one of elements belonging to Group 14 is contained in the oxide semiconductor film, oxygen vacancies are increased in the oxide semiconductor film, and the oxide semiconductor film becomes an n-type film. Thus, the concentration of silicon or carbon (the concentration is measured by SIMS) in the oxide semiconductor film or the concentration of silicon or carbon (the concentration is measured by SIMS) in the vicinity of an interface with the oxide semiconductor film is set to be lower than or equal to 2×10¹⁸ atoms/cm³, or preferably lower than or equal to 2×10¹⁷ atoms/cm³.

In addition, the concentration of alkali metal or alkaline earth metal of the oxide semiconductor film, which is measured by SIMS, is lower than or equal to 1×10¹⁸ atoms/cm³, or preferably lower than or equal to 2×10¹⁶ atoms/cm³. Alkali metal and alkaline earth metal might generate carriers when bonded to an oxide semiconductor, in which case the off-state current of the transistor might be increased. Thus, it is preferable to reduce the concentration of alkali metal or alkaline earth metal of the oxide semiconductor film.

Further, when nitrogen is contained in the oxide semiconductor film, electrons serving as carriers are generated and the carrier density increases, so that the oxide semiconductor film easily becomes n-type. Thus, a transistor including an oxide semiconductor film which contains nitrogen is likely to have normally-on characteristics. For this reason, nitrogen in the oxide semiconductor film is preferably reduced as much as possible; the concentration of nitrogen which is measured by SIMS is preferably set, for example, lower than or equal to 5×10¹⁸ atoms/cm³.

The oxide semiconductor film may have a non-single-crystal structure, for example. The non-single crystal structure includes a c-axis aligned crystalline oxide semiconductor (CAAC-OS) which is described later, a polycrystalline structure, a microcrystalline structure, or an amorphous structure, for example. Among the non-single crystal structure, the amorphous structure has the highest density of defect states, whereas CAAC-OS has the lowest density of defect states.

The oxide semiconductor film may have an amorphous structure, for example. The oxide semiconductor film having the amorphous structure has disordered atomic arrangement and no crystalline component, for example. Alternatively, the oxide film having the amorphous structure has, for example, an absolutely amorphous structure and no crystal part.

Note that the oxide semiconductor film may be a mixed film including two or more of the following: a region having an amorphous structure, a region having a microcrystalline structure, a region having a polycrystalline structure, a region of a CAAC-OS, and a region having a single-crystal structure. The mixed film has a single-layer structure including, for example, two or more of a region having an amorphous structure, a region having a microcrystalline structure, a region having a polycrystalline structure, a CAAC-OS region, and a region having a single-crystal structure in some cases. Furthermore, in some cases, the mixed film has a stacked-layer structure of two or more of a region having an amorphous structure, a region having a microcrystalline structure, a region having a polycrystalline structure, a CAAC-OS region, and a region having a single-crystal structure.

Alternatively, silicon is preferably used as a semiconductor in which a channel of a transistor is formed. Although amorphous silicon may be used as the silicon, silicon having crystallinity is particularly preferable. For example, microcrystalline silicon, polycrystalline silicon, single crystal silicon, or the like is preferably used. In particular, polycrystalline silicon can be formed at a lower temperature than single crystal silicon and has higher field effect mobility and higher reliability than amorphous silicon. When such a polycrystalline semiconductor is used for a pixel, the aperture ratio of the pixel can be improved. Even in the case where pixels are provided at extremely high resolution, a gate driver circuit and a source driver circuit can be formed over a substrate over which the pixels are formed, and the number of components of an electronic device can be reduced.

### <Insulating Layer>

An insulating layer 157 has a function of supplying oxygen to the semiconductor layer 151. Furthermore, the insulating layer 157 may have a function as a protective insulating film of the transistor 100. The insulating layer 157 preferably contains oxygen.

For the insulating layer 157, silicon oxide, silicon oxynitride, silicon nitride, silicon nitride oxide, aluminum nitride, aluminum nitride oxide, aluminum oxide, aluminum oxynitride, gallium oxide, gallium oxynitride, yttrium oxide, yttrium oxynitride, hafnium oxide, hafnium oxynitride, or the like can be used.

The above is the description of each of the components.

### Manufacturing Method Example 1

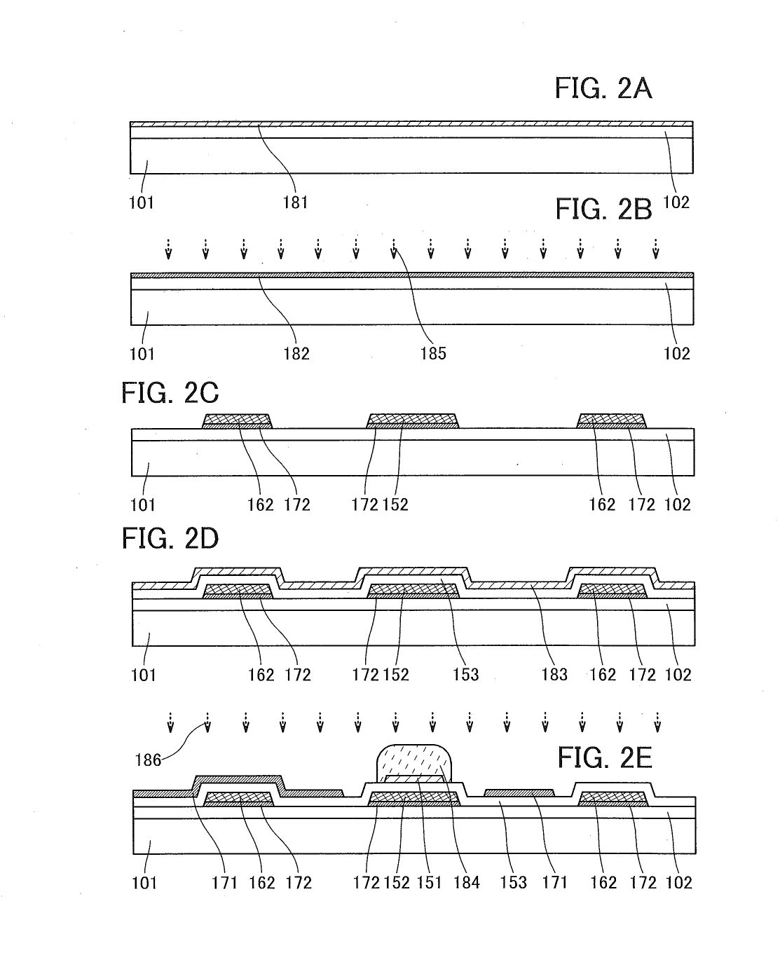

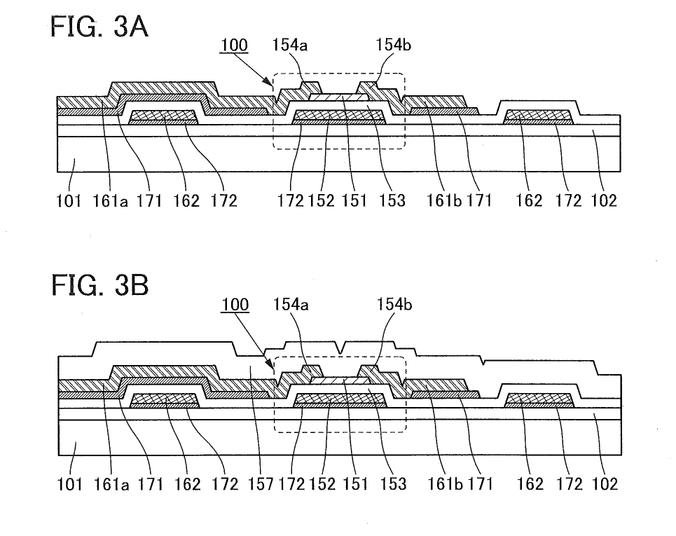

An example of a method for manufacturing the semiconductor device shown in FIGS. 1A and 1B is described below with reference to drawings. FIGS. 2A to 2E and FIGS. 3A and 3B are schematic cross-sectional views illustrating the manufacturing method of the semiconductor device.

Note that the films included in the semiconductor device (i.e., the insulating film, the oxide semiconductor film, the conductive film, and the like) can be formed by any of a sputtering method, a chemical vapor deposition (CVD) method, a vacuum evaporation method, and a pulsed laser deposition (PLD) method. Alternatively, a coating method or a printing method can be used. Although a sputtering method and a plasma enhanced chemical vapor deposition (PECVD) method are typical examples of film formation methods, an atomic layer deposition (ALD) method or a thermal CVD method may also be used. As a thermal CVD method, a metal organic chemical vapor deposition (MOCVD) method may be used, for example.

Deposition by a thermal CVD method may be performed in such a manner that a pressure in a chamber is set to an atmospheric pressure or a reduced pressure, and a source gas and an oxidizer are supplied to the chamber at a time and react with each other in the vicinity of the substrate or over the substrate. Thus, no plasma is generated in the deposition; therefore, a thermal CVD method has an advantage that no defect due to plasma damage is caused.

Deposition by an ALD method may be performed in such a manner that a pressure in a chamber is set to an atmospheric pressure or a reduced pressure, source gases for reaction are sequentially introduced into the chamber, and then the sequence of the gas introduction is repeated. For example, two or more kinds of source gases are sequentially supplied to the chamber by switching switching valves (also referred to as high-speed valves). In such a case, a first source gas is introduced, an inert gas (e.g., argon or nitrogen) or the like is introduced at the same time as or after introduction of the first gas so that the source gases are not mixed, and then a second source gas is introduced. Note that in the case where the first source gas and the inert gas are introduced at a time, the inert gas serves as a carrier gas, and the inert gas may also be introduced at the same time as the introduction of the second source gas. Alternatively, the first source gas may be exhausted by vacuum evacuation instead of the introduction of the inert gas, and then the second source gas may be introduced. The first source gas is adsorbed on the surface of the substrate to form a first single-atomic layer; then the second source gas is introduced to react with the first single-atomic layer; as a result, a second single-atomic layer is stacked over the first single-atomic layer, so that a thin film is formed.

The sequence of the gas introduction is repeated plural times until a desired thickness is obtained, whereby a thin film with excellent step coverage can be formed. The thickness of the thin film can be adjusted by the number of repetition times of the sequence of the gas introduction; therefore, an ALD method makes it possible to accurately adjust a thickness and thus is suitable for manufacturing a minute transistor.

### <Formation of Insulating Layer>

First, an insulating layer 102 is formed over the substrate 101. The insulating layer 102 can be formed, for example, by a sputtering method, a PECVD method, a thermal CVD method, a vacuum evaporation method, a PLD method, or the like.

### <Formation of Anti-Reflection Layer>

Next, a semiconductor film 181 is formed over the insulating layer 102 (see FIG. 2A). The semiconductor film 181 can be formed by a sputtering method, a molecular beam epitaxy (MBE) method, a PECVD method, a thermal CVD method, a PLD method, an ALD method, or the like.

The semiconductor film 181 is formed by a sputtering method with the use of an In—Ga—Zn-based metal oxide target, for example.

Then, the semiconductor film 181 is subjected to treatment 185 to form a semiconductor film 182 (see FIG. 2B). Specifically, as the treatment 185, treatment such as plasma treatment, impurity introduction treatment, or heat treatment is performed.

When plasma treatment is performed as the treatment 185, the treatment is preferably performed in an atmosphere including at least one of a rare gas (such as argon), hydrogen, nitrogen, and ammonia. It is particularly preferable to perform the plasma treatment in an atmosphere including argon, or an atmosphere including both argon and hydrogen.

It is preferable to perform the plasma treatment with the substrate 101 heated. The temperature for heating the substrate 101 is preferably higher than room temperature and lower than or equal to 500° C., more preferably higher than or equal to 100° C. and lower than or equal to 500° C., or further preferably higher than or equal to 300° C. and lower than or equal to 500° C.

For impurity introduction treatment that can be performed as the treatment 185, an ion implantation method, an ion doping method, a plasma immersion ion implantation method, or the like can be used, for example. Here, argon, hydrogen, phosphorus, nitrogen, arsenic, antimony, boron, aluminum, titanium, indium, zinc, helium, neon, fluorine, chlorine, or the like may be used as the impurities introduced into the semiconductor film 181.

When heat treatment is performed as the treatment 185, the treatment may be performed in an atmosphere of argon, hydrogen, nitrogen, or the like.

Note that two or more of plasma treatment, impurity introduction treatment, and heat treatment may be performed in combination.

By the treatment 185, the semiconductor film 182 in which optical absorption characteristics have been changed can be obtained. The semiconductor film 182 has higher conductivity than before performance of the treatment 185 in some cases.

The semiconductor film 182 contains elements used in the above treatment as impurities in some cases. In that case, the semiconductor film 182 has a concentration gradient of the impurities from the top surface of the semiconductor film 182 in a thickness direction in some cases. Alternatively, the impurities are sometimes segregated at the surface of the semiconductor film 182 or in the vicinity of the surface thereof to make a region with a high impurity concentration.

### <Formation of Gate Electrode and Wiring>

Next, a conductive film is formed over the semiconductor film 182. Then, a resist is formed over the conductive film by a photolithography method or the like, and the conductive film and the semiconductor film 182 are partly removed by etching with the use of the resist as an etching mask. The resist is removed after that. Accordingly, the gate electrode 152, the wiring 162, and the anti-reflection layer 172 are formed (see FIG. 2C).

The conductive film can be formed by a sputtering method, a CVD method, a vacuum evaporation method, an ALD method, a PLD method, or the like. Alternatively, a coating method or a printing method can be used. Other than a PECVD method, a thermal CVD method such as an MOCVD method can be used as a CVD method.

### <Formation of Gate Insulating Layer>

Next, the insulating layer 153 is formed to cover the insulating layer 102, the gate electrode 152, the wiring 162, and the anti-reflection layer 172.

The insulating layer 153 can be formed by a sputtering method, a PECVD method, a thermal CVD method, a vacuum evaporation method, a PLD method, or the like.

The insulating layer 153 is preferably an insulating film containing oxygen to improve characteristics of an interface with a semiconductor film 183 formed later.

### <Formation of Semiconductor Layer and Anti-Reflection Layer>

Next, the semiconductor film 183 is formed over the insulating layer 153 (see FIG. 2D).

The semiconductor film 183 can be formed by a method similar to that used for the semiconductor film 181.

After the semiconductor film 183 is formed, heat treatment may be performed at a temperature higher than or equal to 150° C. and lower than the strain point of the substrate, preferably higher than or equal to 200° C. and lower than or equal to 450° C., or further preferably higher than or equal to 300° C. and lower than or equal to 450° C. The heat treatment performed here serves as one kind of treatment for increasing the purity of the oxide semiconductor film and can reduce hydrogen, water, and the like contained in the semiconductor film 183. Note that the heat treatment for the purpose of reducing hydrogen, water, and the like may be performed before or after the semiconductor film 183 is processed into an island shape.

An electric furnace, an RTA apparatus, or the like can be used for the heat treatment performed on the semiconductor film 183. With the use of an RTA apparatus, the heat treatment can be performed at a temperature higher than or equal to the strain point of the substrate if the heating time is short. Therefore, the heat treatment time can be shortened.

Note that the heat treatment performed on the semiconductor film 183 may be performed in an atmosphere of nitrogen, oxygen, ultra-dry air (air in which a water content is 20 ppm or less, preferably 1 ppm or less, further preferably 10 ppb or less), or a rare gas (argon, helium, or the like). The atmosphere of nitrogen, oxygen, ultra-dry air, or a rare gas preferably does not contain hydrogen, water, and the like. Further, after heat treatment performed in a nitrogen atmosphere or a rare gas atmosphere, heat treatment may be additionally performed in an oxygen atmosphere or an ultra-dry air atmosphere. As a result, hydrogen, water, and the like can be released from the oxide semiconductor film and oxygen can be supplied to the oxide semiconductor film at the same time. Consequently, the amount of oxygen vacancies in the oxide semiconductor film can be reduced.

In the case where the semiconductor film 183 is formed by a sputtering method, as a sputtering gas, a rare gas (typically argon), oxygen, or a mixed gas of a rare gas and oxygen is used as appropriate. In the case of using the mixed gas of a rare gas and oxygen, the proportion of oxygen to a rare gas is preferably increased. In addition, increasing the purity of a sputtering gas is necessary. For example, as an oxygen gas or an argon gas used for a sputtering gas, a gas which is highly purified to have a dew point of −40° C. or lower, preferably −80° C. or lower, further preferably −100° C. or lower, or still further preferably −120° C. or lower is used, whereby entry of moisture or the like into the semiconductor film 183 can be minimized.

When the semiconductor film 183 is formed by a sputtering method, each chamber of a sputtering apparatus is preferably evacuated to a high vacuum (to the degree of approximately 5×10⁻⁷ Pa to 1×10⁻⁴ Pa) by an adsorption vacuum pump such as a cryopump so that water and the like acting as impurities for the semiconductor film 183 are removed as much as possible. Alternatively, a turbo molecular pump and a cold trap are preferably combined so as to prevent a backflow of a gas, especially a gas containing carbon or hydrogen from an exhaust system to the inside of the chamber.

Then, a resist is formed over the semiconductor film 183 by a photolithography method or the like, and the semiconductor film 183 is partly removed by etching with the use of the resist as an etching mask. The resist is removed after that. Accordingly, the semiconductor layer 151 and a layer to be the anti-reflection layer 171 later are formed.

Next, a resist 184 is formed to cover the semiconductor layer 151 (see FIG. 2E).

Then, a region of the semiconductor film that is not covered with the resist 184 is subjected to treatment 186 to form the anti-reflection layer 171. For the treatment 186, a method similar to that used for the treatment 185 can be used. The resist 184 is removed after that. Accordingly, the anti-reflection layer 171 and the semiconductor layer 151 are completed.

In performing the treatment 186, the semiconductor layer 151 is not exposed to the treatment since it is covered with the resist 184; accordingly, the semiconductor layer 151 can have favorable semiconductor characteristics. In contrast, the anti-reflection layer 171 has changed optical absorption characteristics due to exposure to the treatment 186.

### <Formation of Source Electrode, Drain Electrode, and Wiring>

Next, a conductive film is formed over the insulating layer 153, the semiconductor layer 151, and the anti-reflection layer 171. Then, a resist is formed over the conductive film by a photolithography method or the like, and the conductive film is partly removed by etching with the use of the resist as an etching mask. The resist is removed after that. Accordingly, the electrode 154a, the electrode 154b, the wiring 161a, the wiring 161b, and the like are formed (see FIG. 3A).

For formation of the conductive film, a method similar to the above-described method can be used.

A surface of the semiconductor layer 151 (on a back channel side) may be cleaned after formation of the electrode 154a, the electrode 154b, the wiring 161a, and the wiring 161b. The cleaning may be performed using, for example, a chemical solution such as phosphoric acid. The cleaning using a chemical solution such as a phosphoric acid can remove impurities (e.g., an element included in the electrode 154a, the electrode 154b, the wiring 161a, and the wiring 161b) attached to the surface of the oxide semiconductor layer 151.

In formation and/or cleaning of the electrode 154a, the electrode 154b, the wiring 161a, and the wiring 161b, the top surface of the semiconductor layer 151 or the anti-reflection layer 171 is etched and a depressed portion is formed in some cases.

Through the above steps, the transistor 100 can be formed.

### <Formation of Insulating Layer>

Next, the insulating layer 157 is formed over the transistor 100, specifically, over the semiconductor layer 151, the anti-reflection layer 171, the electrode 154a, the electrode 154b, the wiring 161a, the wiring 161b, and the insulating layer 153 (see FIG. 3B).

The insulating layer 157 can be formed by a sputtering method, a PECVD method, a thermal CVD method, a vacuum evaporation method, a PLD method, or the like.

Note that the insulating layer 157 preferably has a stacked-layer structure with two or more insulating films.

For example, after a first insulating film is formed, a second insulating film is preferably formed in succession without exposure to the air. After the first insulating film is formed, the second insulating film is formed in succession by adjusting at least one of the flow rate of a source gas, a pressure, a high-frequency power, and a substrate temperature without exposure to the air, whereby the concentration of impurities attributed to the atmospheric component at the interface between the first insulating film and the second insulating film can be reduced and oxygen in the insulating films can be moved to the semiconductor layer 151; accordingly, the amount of oxygen vacancies in the semiconductor layer 151 can be reduced.

For example, as the first insulating film, a silicon oxynitride film can be formed by a PECVD method. In this case, a deposition gas containing silicon and an oxidizing gas are preferably used as a source gas. Typical examples of the deposition gas containing silicon include silane, disilane, trisilane, and silane fluoride. Examples of the oxidizing gas include dinitrogen monoxide and nitrogen dioxide. An insulating film including nitrogen and having a small number of defects can be formed as the first insulating film by a PECVD method under the conditions where the ratio of the oxidizing gas to the deposition gas is higher than 20 times and lower than 100 times, or preferably higher than or equal to 40 times and lower than or equal to 80 times and the pressure in a treatment chamber is lower than 100 Pa, or preferably lower than or equal to 50 Pa.

As the second insulating film, a silicon oxide film or a silicon oxynitride film is formed under the conditions where the substrate placed in a treatment chamber of the PECVD apparatus that is vacuum-evacuated is held at a temperature higher than or equal to 180° C. and lower than or equal to 280° C., or preferably higher than or equal to 200° C. and lower than or equal to 240° C., the pressure is greater than or equal to 100 Pa and less than or equal to 250 Pa, or preferably greater than or equal to 100 Pa and less than or equal to 200 Pa with introduction of a source gas into the treatment chamber, and a high-frequency power of greater than or equal to 0.17 W/cm² and less than or equal to 0.5 W/cm², or preferably greater than or equal to 0.25 W/cm² and less than or equal to 0.35 W/cm² is supplied to an electrode provided in the treatment chamber.

As the deposition conditions of the second insulating film, the high-frequency power having the power density is supplied to the electrode in the treatment chamber having the pressure, so that the degradation efficiency of the source gas in plasma is increased, oxygen radicals are increased, and oxidation of the source gas is promoted. Thus, the oxygen content in the second insulating film becomes higher than that in the stoichiometric composition. On the other hand, in the film formed at a substrate temperature within the above temperature range, the bond between silicon and oxygen is weak, and accordingly, part of oxygen in the film is released by heat treatment in a later step. Thus, it is possible to form an oxide insulating film which contains oxygen at a higher proportion than the stoichiometric composition and from which part of oxygen is released by heating.

Note that the first insulating film serves as a protective film for the semiconductor layer 151 in the formation step of the second insulating film. Therefore, the second insulating film can be formed using the high-frequency power having a high power density while damage to the semiconductor layer 151 is reduced.

Heat treatment may be performed after the insulating layer 157 is formed. The heat treatment can reduce nitrogen oxide included in the insulating layer 157. By the heat treatment, part of oxygen contained in the insulating layer 157 can be moved to the semiconductor layer 151, so that the number of oxygen vacancies in the semiconductor layer 151 can be reduced.

The temperature of the heat treatment performed on the insulating layer 157 is typically higher than or equal to 150° C. and lower than or equal to 400° C., preferably higher than or equal to 300° C. and lower than or equal to 400° C., or further preferably higher than or equal to 320° C. and lower than or equal to 370° C. The heat treatment may be performed in an atmosphere of nitrogen, oxygen, ultra-dry air (air in which a water content is 20 ppm or less, preferably 1 ppm or less, or further preferably 10 ppb or less), or a rare gas (argon, helium, or the like). Note that an electric furnace, an RTA apparatus, or the like can be used for the heat treatment in which it is preferable that hydrogen, water, and the like not be contained in the nitrogen, oxygen, ultra-dry air, or rare gas.

The above is the description of Manufacturing method example 1.

### Manufacturing Method Example 2

A manufacturing method example that is partly different from Manufacturing method example 1 will be described below. Note that description of the portions already described is omitted and only different portions are described.

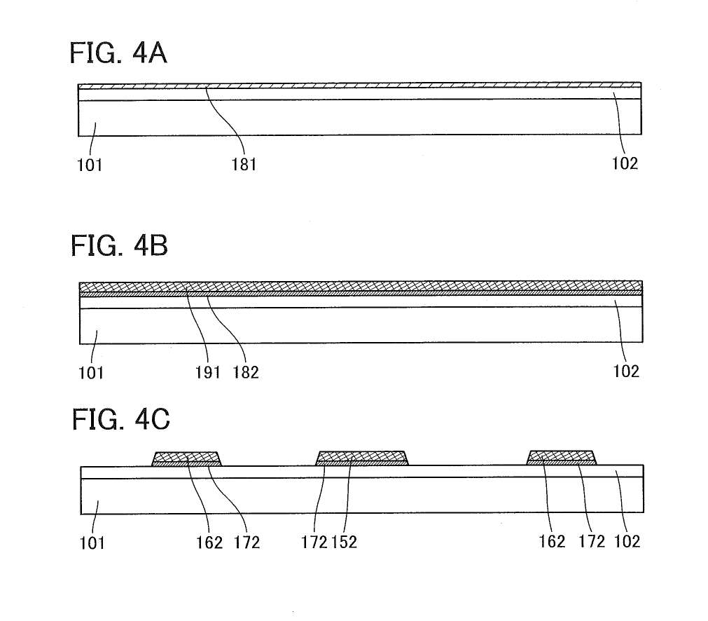

First, the insulating layer 102 and the semiconductor film 181 are formed over the substrate 101 (see FIG. 4A).

Next, a conductive film 191 is formed over the semiconductor film 181.

The conductive film 191 includes an element that can diffuse into the semiconductor film 181 to change optical absorption characteristics of the semiconductor film 181. The conductive film 191 may also include an element that can change conductivity of the semiconductor film 181.

The conductive film 191 preferably includes a metal such as titanium, aluminum, tungsten, copper, or molybdenum.

The conductive film 191 can be formed by a sputtering method, a CVD method, a vacuum evaporation method, or a PLD method. Alternatively, a coating method or a printing method can be used. Although a sputtering method and a plasma enhanced chemical vapor deposition (PECVD) method are typical examples of film formation methods, an atomic layer deposition (ALD) method or a thermal CVD method may also be used. As a thermal CVD method, a metal organic chemical vapor deposition (MOCVD) method may be used, for example.

When the conductive film 191 is formed in contact with the top surface of the semiconductor film 181, the element included in the conductive film 191 diffuses into the semiconductor film 181, so that the semiconductor film 182 whose optical absorption characteristics are changed is formed (see FIG. 4B). Here, if the substrate 101 is heated during the formation of the conductive film 191, diffusion of the element easily occurs and thus the optical absorption characteristics of the semiconductor film 181 can be more effectively changed.

In a step after formation of the conductive film 191, heat treatment is preferably performed. The heat treatment is be performed, for example, at a temperature higher than or equal to 150° C. and lower than or equal to 400° C., preferably higher than or equal to 300° C. and lower than or equal to 400° C., or further preferably higher than or equal to 320° C. and lower than or equal to 370° C. The element diffuses from the conductive film 191 to the semiconductor film 181 by the heat treatment, and thus the optical characteristics of the semiconductor film 181 can be more notably changed. The heat treatment may be performed after processing of the conductive film 191 and the semiconductor film 181. The heat treatment may serve also as the above-described heat treatment.

After that, the conductive film 191 and the semiconductor film 181 are processed, whereby the wiring 162, the gate electrode 152, and the anti-reflection layer 172 are formed (see FIG. 4C).

Subsequent steps can be performed in a way similar to those of Manufacturing method example 1.

The above is the description of Manufacturing method example 2.

### Manufacturing Method Example 3

A manufacturing method example that is partly different from Manufacturing method examples 1 and 2 will be described below. Note that description of the portions already described is omitted and only different portions are described.

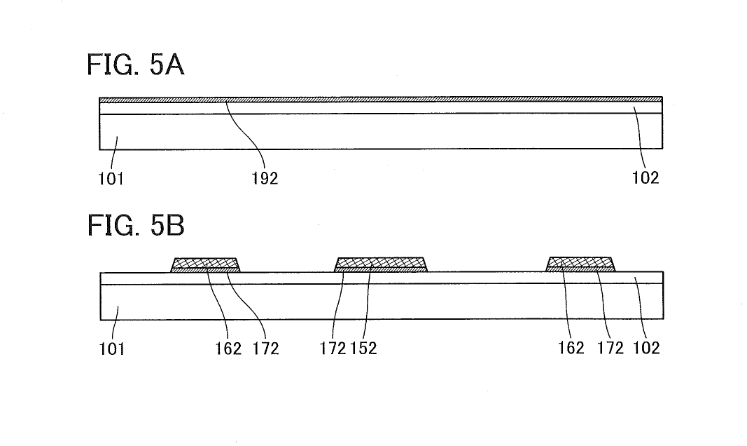

First, the insulating layer 102 is formed over the substrate 101. Then, a semiconductor film 192 is formed (see FIG. 5A).

The semiconductor film 192 includes an oxide semiconductor including nitrogen. For example, a material where the oxide usable for the above-mentioned anti-reflection layers 171 and 172 contains nitrogen is preferably used.

The semiconductor film 192 is formed in an atmosphere including nitrogen in order to make the oxide semiconductor contain nitrogen. For example, an oxide semiconductor film containing nitrogen is formed in an atmosphere including nitrogen by a sputtering method with the use of an In—Ga—Zn-based oxide target.

The semiconductor film 192 containing nitrogen has higher light absorptance with respect to light with a certain wavelength than a semiconductor film without nitrogen. Accordingly, the semiconductor film 192 containing nitrogen can be used as the anti-reflection layer 172 without being subjected to special treatment.

Next, a conductive film is formed over the semiconductor film 192 by a method similar to the above-mentioned method, and then the conductive film and the semiconductor film 192 are processed to form the gate electrode 152, the wiring 162, and the anti-reflection layer 172 (see FIG. 5B).

Subsequent steps can be performed in a way similar to those of Manufacturing method example 1.

The above is the description of Manufacturing method example 3.

In the semiconductor device shown in this embodiment, when light from outside passes through a substrate provided with a transistor, light reflection at wirings or electrodes can be effectively suppressed. Therefore, the wirings or electrodes are less visible in the semiconductor device. Such a semiconductor device can be favorably used for a display device displaying an image, a touch sensor that is provided on a display surface side of a display device and overlaps the display device to operate, a display device with a function as a touch sensor (touch panel), and the like.

At least part of this embodiment can be implemented in combination with any of the embodiments described in this specification as appropriate.

### Embodiment 2

In this embodiment, structure examples of a touch sensor, a touch sensor module provided with a touch sensor, a display device, a touch panel, a touch panel module, and the like of one embodiment of the present invention are described. In the description below, a capacitive type touch sensor is used as a touch sensor.

Note that in this specification and the like, an object in which a connector such as an FPC or a tape carrier package (TCP) is attached to a substrate provided with a touch sensor, or an object in which an integrated circuit (IC) is directly mounted on a substrate by a chip on glass (COG) method is referred to as a touch sensor module in some cases. Furthermore, a device having a function as a touch sensor and a function of displaying an image or the like is referred to as a touch panel (an input/output device) in some cases. Note that an object in which the connector is attached to a touch panel or an object on which an IC is mounted on a touch panel is referred to as a touch panel module or simply referred to as a touch panel in some cases.

A capacitive type touch sensor that can be used for one embodiment of the present invention includes a capacitor. The capacitor can have a stacked-layer structure of a first conductive layer, a second conductive layer, and an insulating layer between the first conductive layer and the second conductive layer, for example. At this time, the first conductive layer and the second conductive layer each function as an electrode of the capacitor. The insulating layer functions as a dielectric.

Out of the first conductive layer and the second conductive layer, the first conductive layer is assumed to be provided on the touch surface (detection surface) side. In the touch sensor of one embodiment of the present invention, a touch motion can be detected by detecting a capacitor formed between an object to be detected such as a finger or a stylus and the first conductive layer. Specifically, the touch motion can be detected by detecting change in the potential of the first conductive layer due to a capacitor formed by a touch motion when a predetermined potential difference is applied between the first conductive layer and the second conductive layer.

Furthermore, a touch panel can be formed by overlapping the touch sensor of one embodiment of the present invention and a display panel including a pixel having a display element. The pixel emits or transmits light to a touch surface (detection surface) side.

In the touch panel, a substrate supporting the touch sensor and a substrate supporting the display element are preferably provided to face each other. Here, an active matrix touch sensor is preferred where a plurality of sensor elements provided in the touch sensor includes both a capacitor and an active element such as a transistor. With such a structure, the touch sensor may be less likely to be affected by noise that is generated when the display element is driven. Thus, a decrease in detection sensitivity can be suppressed, even in the structure in which the touch sensor and the display element are provided between the two substrates to be close to each other. In particular, in the case where a flexible material is used for the pair of substrates, a flexible touch panel that is thin and lightweight can be obtained.

An anti-reflection layer of one embodiment of the present invention is used between the substrate positioned closer to a viewer side and supporting a touch sensor, and a wiring over the substrate. When the touch sensor with such a structure and a display panel are overlapped with each other to form a touch panel, the wiring is inhibited from being visible when seen from a viewer side, and the touch panel can have high viewability.

A specific structure examples of one embodiment of the present invention is described below with reference to drawings.

### Structure Example

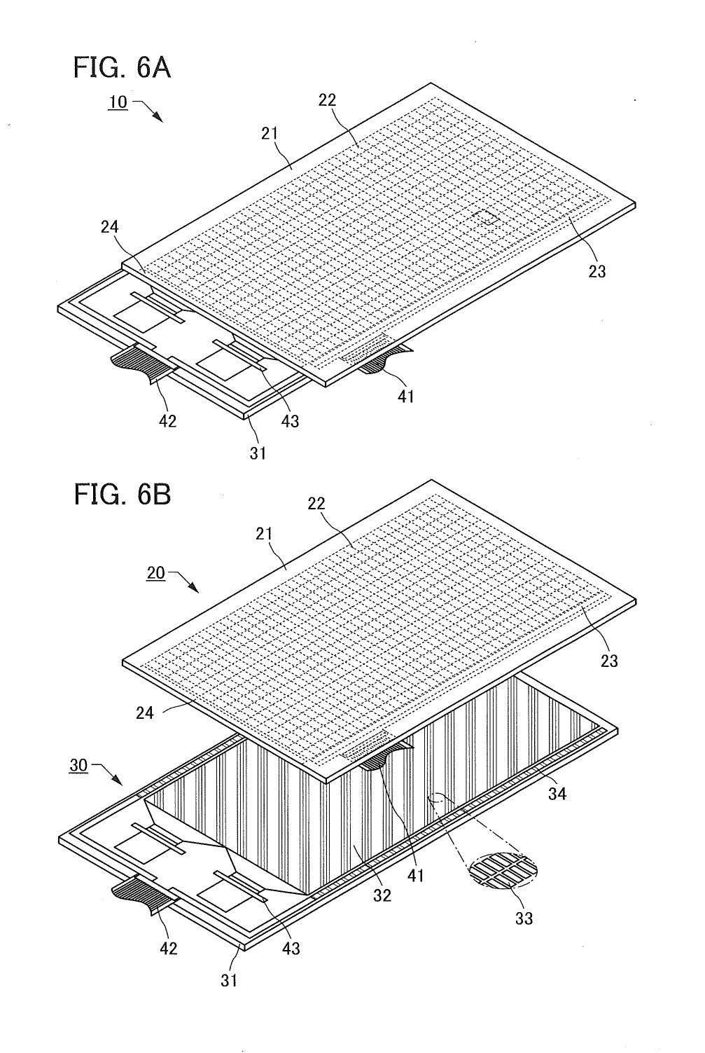

FIG. 6A is a schematic perspective view of a touch panel module 10 of one embodiment of the present invention. FIG. 6B is a developed view of the schematic perspective view of the touch panel module 10. In the touch panel module 10, a touch sensor module 20 and a display panel 30 are provided to overlap with each other.

In the touch sensor module 20, an FPC 41 is provided for a touch sensor (also referred to as a touch sensor panel) including a sensor element (also referred to as a sensing element) 22 over a first substrate 21. A plurality of sensor elements 22 is provided in a matrix over the first substrate 21. Circuits 23 and 24 electrically connected to the sensor elements 22 are preferably provided over the first substrate 21.

A circuit having a function of selecting a plurality of sensor elements 22 can be used for at least one of the circuits 23 and 24. A circuit having a function of outputting a signal from the sensor element 22 can be used for at least one of the circuits 23 and 24.

The FPC 41 has a function of supplying a signal from the outside to at least one of the circuits 23 and 24 and the sensor element 22. In addition, the FPC 41 has a function of outputting a signal from at least one of the circuits 23 and 24 and the sensor element 22 to the outside.

In the display panel 30, a display portion 32 is provided over a second substrate 31. The display portion 32 includes a plurality of pixels 33 arranged in a matrix. A circuit 34 electrically connected to the pixel 33 in the display portion 32 is preferably provided over the second substrate 31. For example, a circuit functioning as a gate driver circuit can be used for the circuit 34.

An FPC 42 has a function of supplying a signal from the outside to at least one of the display portion 32 and the circuit 34. In FIGS. 6A and 6B, a terminal 43 is provided for the second substrate 31. An FPC can be attached to the terminal 43, an IC functioning as a source driver circuit can be directly mounted on the terminal 43 by a COG method or a COF method, or an FPC, a TAB, a TCP, or the like on which an IC is mounted can be attached to the terminal 43, for example. Note that an object in which an IC or a connector such as an FPC is mounted on the display panel 30 can be referred to as a display panel module.

The touch panel module 10 of one embodiment of the present invention can output positional information based on the change in capacitance by the plurality of sensor elements 22 at the time of a touch motion. Furthermore, the display portion 32 can display an image. In other words, the touch panel module 10 can be also referred to as an input/output device.

### [Stacked-Layer Structure Included in Touch Panel]

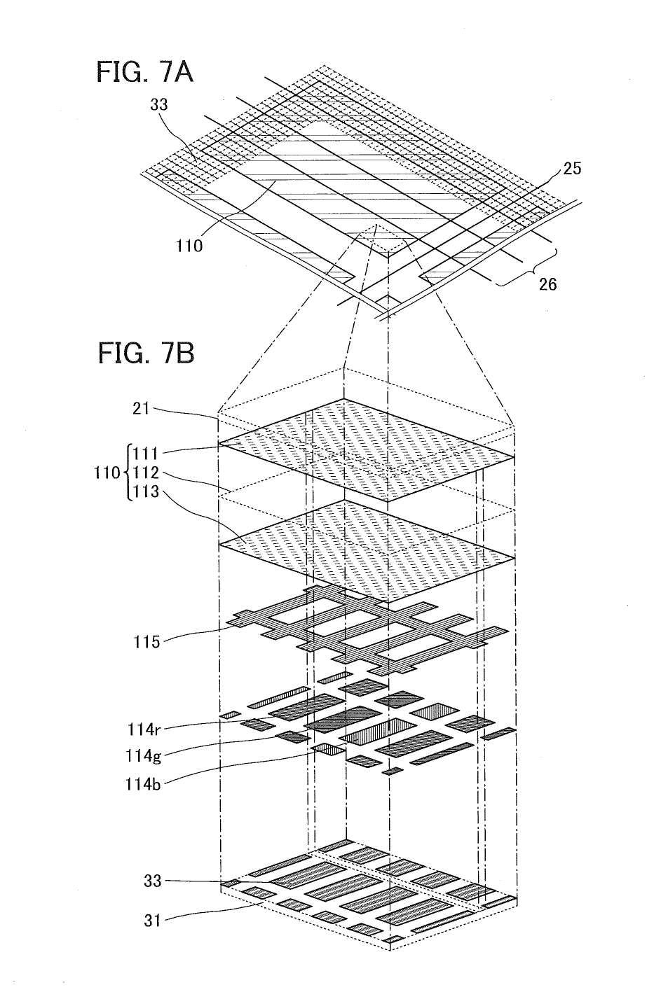

FIG. 7A is an enlarged schematic view of a region surrounded by a dashed line in FIG. 6A.

FIG. 7A shows an example in which a capacitor 110 included in the sensor element shown in FIG. 6A, the pixel 33, a wiring 25, and wirings 26 are provided.

A plurality of capacitors 110 is arranged in a matrix. The wiring 25 is provided between two adjacent capacitors 110. A plurality of wirings 26 is provided in a direction crossing the wiring 25.

A plurality of pixels 33 is arranged in a matrix. In the plurality of pixels 33, some pixels are provided to overlap with the capacitor 110, and some other pixels are provided to overlap with a region between two adjacent capacitors 110.

The pixel 33 includes at least a display element. As the display element, a light-emitting element such as an organic electroluminescence (EL) element is preferably used. In addition, any of various display elements such as elements (electronic ink) that perform display by an electrophoretic method, an electronic liquid powder (registered trademark) method, an electrowetting method, or the like; MEMS shutter display elements; optical interference type MEMS display elements; and liquid crystal elements can be used as the display element.

Furthermore, this embodiment can be used in a transmissive liquid crystal display, a transflective liquid crystal display, a reflective liquid crystal display, a direct-view liquid crystal display, or the like. In the case of a transflective liquid crystal display or a reflective liquid crystal display, some of or all of pixel electrodes function as reflective electrodes. For example, some of or all of pixel electrodes are formed to contain aluminum, silver, or the like. In such a case, a memory circuit such as an SRAM can be provided under the reflective electrodes, which leads to lower power consumption. A structure suitable for employed display elements can be selected from among a variety of structures of pixel circuits.

FIG. 7B is a developed schematic view of a stacked-layer structure in a region overlapping with the capacitor 110. As shown in FIG. 7B, a first conductive layer 111, an insulating layer 112, a second conductive layer 113, a light-blocking layer 115, coloring layers 114r, 114g, and 114b, and pixels 33 are provided between the first substrate 21 and the second substrate 31.

Note that in the case of describing common points of the coloring layers 114r, 114g, and 114b without distinguishing from one another, they are in some cases simply referred to as the coloring layers 114.

The first conductive layer 111, the second conductive layer 113, and the insulating layer 112 between the first conductive layer 111 and the second conductive layer 113 form the capacitor 110.

Each coloring layer 114 has a function of transmitting light in a particular wavelength range. Here, the coloring layer 114r transmits red light, the coloring layer 114g transmits green light, and the coloring layer 114b transmits blue light. The pixel 33 and one of the coloring layers 114 are provided to overlap with each other, whereby only light in a particular wavelength range in light emitted from the pixels 33 can be transmitted to the first substrate 21 side.

The light-blocking layer 115 has a function of blocking visible light. The light-blocking layer 115 is provided to overlap with a region between two adjacent coloring layers 114. In the example shown in FIG. 7B, the light-blocking layer 115 has an opening provided to overlap with the pixel 33 and the coloring layer 114.

Note that in FIG. 7B, the light-blocking layer 115 is provided closer to the first substrate 21 side than the coloring layer 114 is; however, the coloring layer 114 may be provided closer to the first substrate 21 side than the light-blocking layer 115 is.

The first conductive layer 111, the insulating layer 112, and the second conductive layer 113 have a region overlapping with the pixel 33 and the coloring layer 114. Therefore, a material that transmits visible light is preferably used for each of the first conductive layer 111, the insulating layer 112, and the second conductive layer 113.

### Cross-Sectional Structure Example

A cross-sectional structure example of the touch panel module 10 is described below.

### Cross-Sectional Structure Example 1

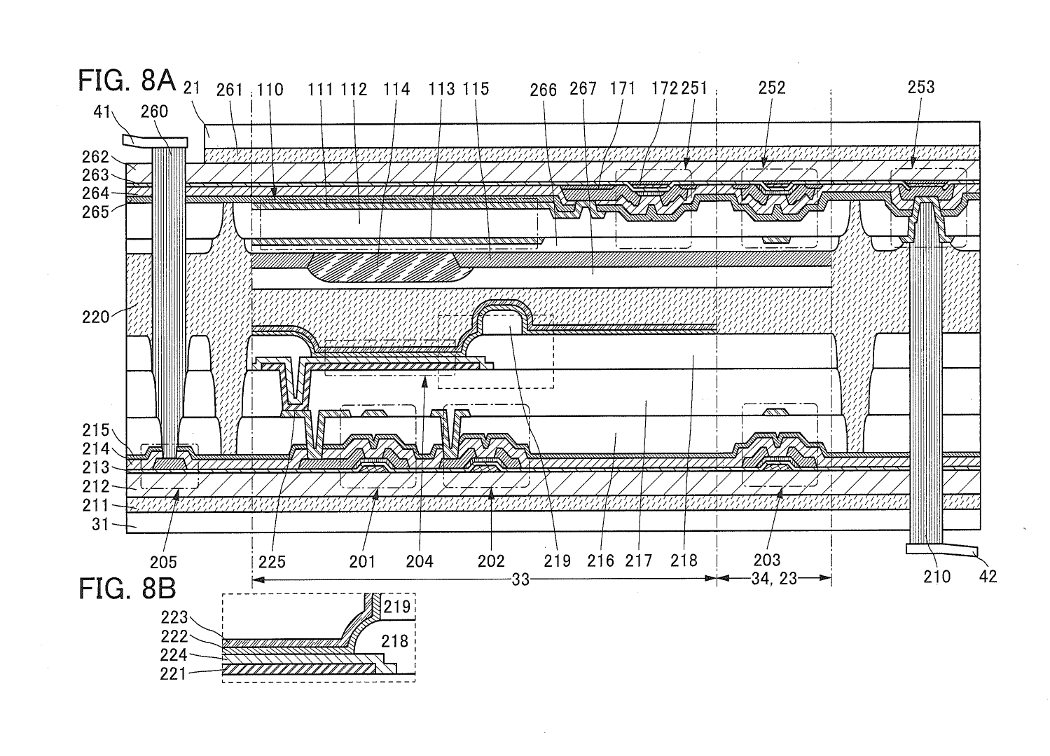

FIG. 8A is a cross-sectional schematic view of a touch panel module of one embodiment of the present invention. In the touch panel module shown in FIG. 8A, an active matrix touch sensor and a display element are provided between a pair of substrates, and therefore, the thickness of the touch panel module can be reduced. Note that in this specification and the like, a touch sensor in which sensor elements each include an active element is referred to as an active matrix touch sensor.

The touch panel module has a structure in which the first substrate 21 and the second substrate 31 are bonded to each other with a bonding layer 220. The capacitor 110, a transistor 251, a transistor 252, a contact portion 253, the coloring layer 114, the light-blocking layer 115, and the like are provided on the second substrate 31 side of the first substrate 21. Transistors 201 to 203, a light-emitting element 204, a contact portion 205, and the like are provided over the second substrate 31.

An insulating layer 212, an insulating layer 213, an insulating layer 214, an insulating layer 215, an insulating layer 216, an insulating layer 217, an insulating layer 218, a spacer 219, a conductive layer 225, and the like are provided over the second substrate 31 with a bonding layer 211 provided therebetween.

The light-emitting element 204 is provided over the insulating layer 217. The light-emitting element 204 includes a first electrode 221, an EL layer 222, and a second electrode 223 (see FIG. 8B). An optical adjustment layer 224 is provided between the first electrode 221 and the EL layer 222. The insulating layer 218 is provided to cover end portions of the first electrode 221 and the optical adjustment layer 224.

In FIG. 8A, the transistor 201 for controlling current and the transistor 202 for controlling switching are provided in the pixel 33. One of a source and a drain of the transistor 201 is electrically connected to the first electrode 221 through the conductive layer 225.

In FIG. 8A, an example where the transistor 203 is provided in the circuit 34 is shown.

In the example illustrated in FIG. 8A, the transistors 201 and 203 each have a structure in which a semiconductor layer where a channel is formed is provided between two gate electrodes. Such transistors can have a higher field-effect mobility and thus have higher on-state current than other transistors. Consequently, a circuit capable of high-speed operation can be obtained. Furthermore, the area occupied by a circuit portion can be reduced. The use of the transistor having high on-state current can reduce signal delay in wirings and can suppress display unevenness even in a display panel or a touch panel in which the number of wirings is increased because of increase in size or resolution.

Note that the transistor included in the circuit 34 and the transistor included in the pixel 33 may have the same structure. Transistors included in the circuit 34 may have the same structure or different structures. Transistors included in the pixel 33 may have the same structure or different structures. Transistors provided on the first substrate 21 side (the transistor 251, the transistor 252, and the like) may have the same structure or different structures.

In the example illustrated in FIG. 8A, a light-emitting element with a top-emission structure is used as the light-emitting element 204. The light-emitting element 204 emits light toward the second electrode 223 side. The transistors 201 and 202, the capacitor, a wiring, and the like are provided closer to the second substrate 31 side than a light-emitting region of the light-emitting element 204 is to overlap with the light-emitting region. Thus, an aperture ratio of the pixel 33 can be increased.

An insulating layer 262, an insulating layer 263, an insulating layer 264, an insulating layer 265, the first conductive layer 111, the insulating layer 112, the second conductive layer 113, an insulating layer 266, the coloring layer 114, the light-blocking layer 115, and the like are provided on the second substrate 31 side of the first substrate 21 with a bonding layer 261 provided therebetween. An overcoat 267 covering the coloring layer 114 and the light-blocking layer 115 may be provided.

The first conductive layer 111 is electrically connected to one of a source and a drain of the transistor 251. The second conductive layer 113 is provided on the second substrate 31 side of the insulating layer 112.

The light-emitting region of the light-emitting element 204 and the coloring layer 114 are provided to overlap with each other, and light is emitted from the light-emitting element 204 toward the first substrate 21 side through the coloring layer 114.

By using a flexible material for the first substrate 21 and the second substrate 31, a flexible touch panel can be achieved.

A color filter method is employed in the touch panel of one embodiment of the present invention. For example, a structure where pixels of three colors with the color filters of red (R), green (G), and blue (B) expresses one color can be employed. In addition, a pixel of white (W) or yellow (Y) may be used for the structure.

Owing to the combination of the coloring layer 114 and a microcavity structure using the optical adjustment layer 224, light with high color purity can be extracted from the touch panel of one embodiment of the present invention. The thickness of the optical adjustment layer 224 may be varied depending on the color of the pixel. Some pixels do not necessarily have the optical adjustment layer 224.

An EL layer that emits white light is preferably used as the EL layer 222 of the light-emitting element 204. By using the light-emitting element 204, it is not necessary to form the EL layers 222 expressing different colors in pixels. Therefore, the cost can be reduced, and the high resolution is achieved easily. Furthermore, by varying the thickness of the optical adjustment layer 224 in pixels, light with a wavelength suitable for each pixel can be extracted, which increases color purity. Note that the EL layers 222 expressing different colors may be formed in pixels, in which case the optical adjustment layer 224 and the coloring layer 114 are not necessarily used.

An opening is provided in the insulating layers and the like in a region overlapping with the contact portion 205 provided over the second substrate 31, and the contact portion 205 and the FPC 41 are electrically connected to each other with a connection layer 260 provided in the opening. Furthermore, an opening is provided in the insulating layers and the like in a region overlapping with the first substrate 21, and the contact portion 253 and the FPC 42 are electrically connected to each other through a connection layer 210 provided in the opening.

In the structure illustrated in FIG. 8A, the contact portion 205 has a conductive layer formed by processing a conductive film for the source electrode and the drain electrode of the transistor. Furthermore, the contact portion 253 has a stacked-layer structure of a conductive layer formed by processing a conductive film for the gate electrode of the transistor, a conductive layer formed by processing a conductive film for the source electrode and the drain electrode of the transistor, and a conductive layer formed by processing a conductive film for the second conductive layer 113. The contact portion preferably has a stacked-layer structure of a plurality of conductive layers as described above because electric resistance can be reduced and mechanical strength can be increased.

As the connection layer 210 and the connection layer 260, any of various anisotropic conductive films (ACF), anisotropic conductive pastes (ACP), or the like can be used.

A material in which impurities such as water or hydrogen do not easily diffuse is preferably used for the insulating layer 212 and the insulating layer 262. That is, the insulating layer 212 and the insulating layer 262 can each function as a barrier film. Such a structure can effectively suppress diffusion of the impurities to the light-emitting element 204 and the transistors even in the case of using a material permeable to moisture for the first substrate 21 and the second substrate 31, and a highly reliable touch panel can be achieved.

As shown in FIGS. 8A and 8B, the anti-reflection layer 171 is provided between the first substrate 21 and a wiring that is formed by the same step as that of forming the source and drain electrodes of the transistor 251 and the transistor 252 provided on one side of the first substrate 21. In addition, the anti-reflection layer 172 is provided between the first substrate 21 and a wiring that is formed by the same step as that of forming the gate electrode of the transistor 251 and the transistor 252. Therefore, these wirings are inhibited from being visible from the first substrate 21 side that is a detection surface side.

Here is the structure including the wiring that is formed by the same step as that of forming the gate electrode of the transistors and the wiring that is formed by the same step as that of forming the source and drain electrodes of the transistors. If a wiring different from them is provided, it is preferred to provide a similar anti-reflection layer between the wiring and the first substrate 21.

### [Components]

The above components are described below.

The transistor includes a conductive layer functioning as the gate electrode, the semiconductor layer, a conductive layer functioning as the source electrode, a conductive layer functioning as the drain electrode, and an insulating layer functioning as a gate insulating layer. FIG. 8A shows the case where a bottom-gate transistor is used.

Note that there is no particular limitation on the structure of the transistor included in the touch panel of one embodiment of the present invention. For example, a forward staggered transistor or an inverted staggered transistor may be used. A top-gate transistor or a bottom-gate transistor may be used. A semiconductor material used for the transistor is not particularly limited, and for example, an oxide semiconductor, silicon, or germanium can be used.

There is no particular limitation on the crystallinity of a semiconductor material used for the transistor, and an amorphous semiconductor or a semiconductor having crystallinity (a microcrystalline semiconductor, a polycrystalline semiconductor, a single-crystal semiconductor, or a semiconductor partly including crystal regions) may be used. It is preferable that a semiconductor having crystallinity be used, in which case deterioration of the transistor characteristics can be suppressed.

As a semiconductor material for the semiconductor layer of the transistor, an element of Group 4, a compound semiconductor, or an oxide semiconductor can be used, for example. Typically, a semiconductor containing silicon, a semiconductor containing gallium arsenide, an oxide semiconductor containing indium, or the like can be used.

An oxide semiconductor like the one shown in Embodiment 1 is preferably used as a semiconductor in which a channel of a transistor is formed.

In particular, in an oxide semiconductor film including an oxide semiconductor where no grain boundary is observed, generation of a crack caused by stress of when a display panel is bent is prevented. Therefore, such an oxide semiconductor can be preferably used for a flexible touch panel which is used in a bent state, or the like.

Moreover, the use of such an oxide semiconductor for the semiconductor layer makes it possible to provide a highly reliable transistor in which a change in the electrical characteristics is suppressed.

Charge accumulated in a capacitor through a transistor can be held for a long time because of the low off-state current of the transistor. When such a transistor is used for a pixel, operation of a driver circuit can be stopped while a gray scale of an image displayed in each display region is maintained. As a result, a display device with an extremely low power consumption can be obtained.

Alternatively, silicon is preferably used as a semiconductor in which a channel of a transistor is formed. Although amorphous silicon may be used as silicon, silicon having crystallinity is particularly preferable. For example, microcrystalline silicon, polycrystalline silicon, single crystal silicon, or the like is preferably used. In particular, polycrystalline silicon can be formed at a lower temperature than single crystal silicon and has higher field effect mobility and higher reliability than amorphous silicon. When such a polycrystalline semiconductor is used for a pixel, the aperture ratio of the pixel can be improved. Even in the case where pixels are provided at extremely high resolution, a gate driver circuit and a source driver circuit can be formed over a substrate over which the pixels are formed, and the number of components of an electronic device can be reduced.

As conductive layers such as a gate, a source, and a drain of the transistor and a wiring and an electrode in the touch panel, a material shown in Embodiment 1 can be used.

As a light-transmitting conductive material, a conductive oxide such as indium oxide, indium tin oxide, indium zinc oxide, zinc oxide, or zinc oxide to which gallium is added, or graphene can be used. Alternatively, a metal material such as gold, silver, platinum, magnesium, nickel, tungsten, chromium, molybdenum, iron, cobalt, copper, palladium, or titanium, or an alloy material containing any of these metal materials can be used. Alternatively, a nitride of the metal material (e.g., titanium nitride) or the like may be used. In the case of using the metal material or the alloy material (or the nitride thereof), the thickness is set small enough to be able to transmit light. Alternatively, a stack of any of the above materials can be used as the conductive layer. For example, a stack of indium tin oxide and an alloy of silver and magnesium is preferably used because the conductivity can be increased.

Examples of an insulating material that can be used for the insulating layers, the overcoat 267, the spacer 219, and the like include a resin such as acrylic or epoxy resin, a resin having a siloxane bond, and an inorganic insulating material such as silicon oxide, silicon oxynitride, silicon nitride oxide, silicon nitride, or aluminum oxide.

As described above, the light-emitting element is preferably provided between a pair of insulating films with low water permeability. Thus, impurities such as water can be prevented from entering the light-emitting element, leading to prevention of a decrease in the reliability of the light-emitting device.

As an insulating film with low water permeability, a film containing nitrogen and silicon (e.g., a silicon nitride film or a silicon nitride oxide film), a film containing nitrogen and aluminum (e.g., an aluminum nitride film), or the like can be used. Alternatively, a silicon oxide film, a silicon oxynitride film, an aluminum oxide film, or the like can be used.

For example, the water vapor transmittance of the insulating film with low water permeability is lower than or equal to 1×10⁻⁵ [g/(m²·day)], preferably lower than or equal to 1×10⁻⁶ [g/(m²·day)], further preferably lower than or equal to 1×10⁻⁷ [g/(m²·day)], still further preferably lower than or equal to 1×10⁻⁸ [g/(m²·day)].

For the bonding layers, a curable resin such as a heat curable resin, a photocurable resin, or a two-component type curable resin can be used. For example, a resin such as an acrylic resin, a urethane resin, an epoxy resin, or a resin having a siloxane bond can be used.

The EL layer 222 includes at least a light-emitting layer. In addition to the light-emitting layer, the EL layer 222 may further include one or more layers containing any of a substance with a high hole-injection property, a substance with a high hole-transport property, a hole-blocking material, a substance with a high electron-transport property, a substance with a high electron-injection property, a substance with a bipolar property (a substance with a high electron- and hole-transport property), and the like.

For the EL layer 222, either a low molecular compound or a high molecular compound can be used, and an inorganic compound may be used. Each of the layers included in the EL layer 222 can be formed by any of the following methods: an evaporation method (including a vacuum evaporation method), a transfer method, a printing method, an inkjet method, a coating method, and the like.

As examples of a material that can be used for the light-blocking layer 115, carbon black, a metal oxide, and a composite oxide containing a solid solution of a plurality of metal oxides can be given.

As examples of a material that can be used for the coloring layer 114, a metal material, a resin material, and a resin material containing a pigment or dye can be given.

### Manufacturing Method Example

Here, a method for manufacturing a flexible touch panel is described.

For convenience, a structure including a pixel and a circuit, a structure including an optical member such as a color filter, or a structure including a touch sensor is referred to as an element layer. An element layer includes a display element, for example, and may include a wiring electrically connected to the display element or an element such as a transistor used in a pixel or a circuit in addition to the display element.

Here, a support body (e.g., the first substrate 21 or the second substrate 31) with an insulating surface where an element layer is formed is referred to as a base material.

As a method for forming an element layer over a flexible base material provided with an insulating surface, there are a method in which an element layer is formed directly over a base material, and a method in which an element layer is formed over a supporting base material that has stiffness and then the element layer is separated from the supporting base material and transferred to the base material.

In the case where a material of the base material can withstand heating temperature in a process for forming the element layer, it is preferable that the element layer be formed directly over the base material, in which case a manufacturing process can be simplified. At this time, the element layer is preferably formed in a state where the base material is fixed to the supporting base material, in which case transfer thereof in an apparatus and between apparatuses can be easy.

In the case of employing the method in which the element layer is formed over the supporting base material and then transferred to the base material, first, a separation layer and an insulating layer are stacked over the supporting base material, and then the element layer is formed over the insulating layer. Next, the element layer is separated from the supporting base material and then transferred to the base material. At this time, a material is selected that would causes separation at an interface between the supporting base material and the separation layer, at an interface between the separation layer and the insulating layer, or in the separation layer.

For example, it is preferable that a stacked layer of a layer including a high-melting-point metal material, such as tungsten, and a layer including an oxide of the metal material be used as the separation layer, and a stacked layer of a plurality of layers, such as a silicon nitride layer and a silicon oxynitride layer be used over the separation layer. The use of the high-melting-point metal material is preferable because the degree of freedom of the process for forming the element layer can be increased.

The separation may be performed by application of mechanical power, by etching of the separation layer, by dripping of a liquid into part of the separation interface to penetrate the entire separation interface, or the like. Alternatively, separation may be performed by heating the separation interface by utilizing a difference in thermal expansion coefficient.

The separation layer is not necessarily provided in the case where separation can occur at an interface between the supporting base material and the insulating layer. For example, with the use of glass as the supporting base material and an organic resin such as polyimide as the insulating layer, a separation trigger may be made by locally heating part of the organic resin by laser light or the like, and separation may be performed at an interface between the glass and the insulating layer. Alternatively, a metal layer may be provided between the supporting base material and the insulating layer formed of an organic resin, and separation may be performed at the interface between the metal layer and the insulating layer by heating the metal layer by feeding a current to the metal layer. In that case, the insulating layer formed of an organic resin can be used as a base material.

Examples of such a base material having flexibility include polyester resins such as polyethylene terephthalate (PET) and polyethylene naphthalate (PEN), a polyacrylonitrile resin, a polyimide resin, a polymethyl methacrylate resin, a polycarbonate (PC) resin, a polyethersulfone (PES) resin, a polyamide resin, a cycloolefin resin, a polystyrene resin, a polyamide imide resin, and a polyvinyl chloride resin. In particular, it is preferable to use a material with a low thermal expansion coefficient, and for example, a polyamide imide resin, a polyimide resin, PET, or the like with a thermal expansion coefficient lower than or equal to 30×10⁻⁶/K can be suitably used. A substrate in which a fibrous body is impregnated with a resin (also referred to as prepreg) or a substrate whose thermal expansion coefficient is reduced by mixing an inorganic filler with an organic resin can also be used.

In the case where a fibrous body is included in the above material, a high-strength fiber of an organic compound or an inorganic compound is used as the fibrous body. The high-strength fiber is specifically a fiber with a high tensile elastic modulus or a fiber with a high Young's modulus. Typical examples thereof include a polyvinyl alcohol based fiber, a polyester based fiber, a polyamide based fiber, a polyethylene based fiber, an aramid based fiber, a polyparaphenylene benzobisoxazole fiber, a glass fiber, and a carbon fiber. As the glass fiber, glass fiber using E glass, S glass, D glass, Q glass, or the like can be used. These fibers may be used in a state of a woven fabric or a nonwoven fabric, and a structure body in which this fibrous body is impregnated with a resin and the resin is cured may be used as the flexible substrate. The structure body including the fibrous body and the resin is preferably used as the flexible substrate, in which case the reliability against bending or breaking due to local pressure can be increased.

Alternatively, glass, metal, or the like that is thin enough to have flexibility can be used as the base material. Alternatively, a composite material where glass and a resin material are attached to each other may be used.

In the structure of FIG. 8A, for example, a first separation layer and the insulating layer 262 are formed in this order over a first supporting base material, and then other components are formed thereover. Separately, a second separation layer and the insulating layer 212 are formed in this order over a second supporting base material, and then upper components are formed. Next, the first supporting base material and the second supporting base material are bonded to each other using the bonding layer 220. After that, separation at an interface between the second separation layer and the insulating layer 212 is conducted so that the second supporting base material and the second separation layer are removed, and then the second substrate 31 is bonded to the insulating layer 212 using the bonding layer 211. Further, separation at an interface between the first separation layer and the insulating layer 262 is conducted so that the first supporting base material and the first separation layer are removed, and then the first substrate 21 is bonded to the insulating layer 262 using the adhesive layer 261. Note that either side may be subjected to separation and attachment first.

The above is the description of a manufacturing method of a flexible touch panel.

### Cross-Sectional Structure Example 2

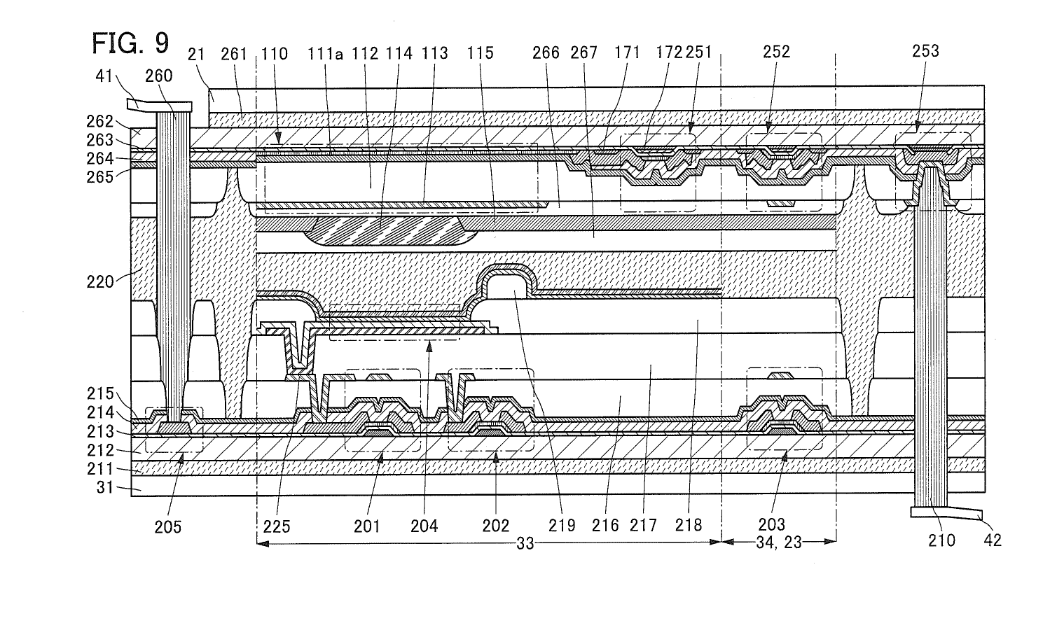

FIG. 9 is a cross-sectional structure example whose structure is partly different from that of FIGS. 8A and 8B. The structure in FIG. 9 is mainly different from that of FIGS. 8A and 8B in a structure of the first conductive layer 111.

FIG. 9 shows an example where a first conductive layer 111a including a semiconductor layer formed by processing the same film as that for the semiconductor layers of the transistor 251 and the transistor 252 is used instead of the first conductive layer 111 of FIGS. 8A and 8B. The first conductive layer 111a is in contact with the insulating layer 265.

Here, the first conductive layer 111a preferably includes an oxide semiconductor. An oxide semiconductor is a semiconductor material whose resistivity can be controlled by oxygen vacancies in the film of the semiconductor material and/or the concentration of impurities such as hydrogen or water in the film of the semiconductor material. Therefore, even when the semiconductor layer used for the first conductive layer 111a and the semiconductor layers used for the transistors are formed by processing the same semiconductor film, resistivity of these semiconductor layers can be controlled by increasing or decreasing oxygen vacancies and/or the concentration of impurities.

Specifically, plasma treatment is performed on an oxide semiconductor layer included in the first conductive layer 111a serving as an electrode of the capacitor 110 so that oxygen vacancies in the oxide semiconductor layer and/or impurities such as hydrogen and water in the oxide semiconductor layer is increased. Accordingly, the first conductive layer 111a includes an oxide semiconductor layer which can have a high carrier density and a low resistance. Alternatively, an insulating film (insulating layer 265) containing hydrogen is formed in contact with the oxide semiconductor layer to diffuse hydrogen from the insulating film containing hydrogen to the oxide semiconductor layer, so that the oxide semiconductor layer can have a high carrier density and a low resistance. Such an oxide semiconductor layer can be used for the first conductive layer 111a.

The insulating layer 264 is provided over the transistor 251 and the transistor 252 to prevent the oxide semiconductor layers thereof from being subjected to the plasma treatment. By provision of the insulating layer 264, the structure where the oxide semiconductor layers are not in contact with the insulating layer 265 containing hydrogen can be obtained. With the use of an insulating film capable of releasing oxygen as the insulating layer 264, oxygen can be supplied to the oxide semiconductor layers of the transistors. The oxide semiconductor layer to which oxygen is supplied becomes an oxide semiconductor layer in which oxygen vacancies in the film or at the interface are reduced and has a high resistance. Note that as the insulating film capable of releasing oxygen, a silicon oxide film, a silicon oxynitride film, and the like can be used, for example.

As the plasma treatment to be performed on the oxide semiconductor layer, plasma treatment using a gas containing one of a rare gas (He, Ne, Ar, Kr, or Xe), phosphorus, boron, hydrogen, and nitrogen is typical. Specifically, plasma treatment in an Ar atmosphere, plasma treatment in a mixed gas atmosphere of Ar and hydrogen, plasma treatment in an ammonia atmosphere, plasma treatment in a mixed gas atmosphere of Ar and ammonia, plasma treatment in a nitrogen atmosphere, or the like can be employed.

By the plasma treatment, an oxygen vacancy is formed in a lattice from which oxygen is released (or in a portion from which oxygen is released) in the oxide semiconductor layer. The oxygen vacancy might cause carrier generation. Further, when hydrogen is supplied from an insulating film that is in the vicinity of the oxide semiconductor layer, specifically, that is in contact with the lower surface or the upper surface of the oxide semiconductor layer, and hydrogen enters the oxygen vacancy, an electron serving as a carrier might be generated. Therefore, the oxide semiconductor layer used for the first conductive layer 111a where oxygen vacancies are increased by the plasma treatment has a higher carrier density than the oxide semiconductor layers of the transistors.

The oxide semiconductor layers of the transistors in which oxygen vacancies are reduced and the hydrogen concentration is reduced can be referred to as a highly purified intrinsic or substantially highly purified intrinsic oxide semiconductor layer. The term “substantially intrinsic” refers to the state where an oxide semiconductor has a carrier density lower than 1×10¹⁷/cm³, preferably lower than 1×10¹⁵/cm³, or further preferably lower than 1×10¹³/cm³. Furthermore, the state in which the impurity concentration is low and the density of defect states is low (the amount of oxygen vacancies is small) is referred to as “highly purified intrinsic” or “substantially highly purified intrinsic”. A highly purified intrinsic or substantially highly purified intrinsic oxide semiconductor has few carrier generation sources, and thus has a low carrier density in some cases. Thus, a transistor including the oxide semiconductor film in which a channel region is formed is likely to have positive threshold voltage (normally-off characteristics). The highly purified intrinsic or substantially highly purified intrinsic oxide semiconductor layer has a low density of defect states and accordingly can have a low density of trap states.

Furthermore, the highly purified intrinsic or substantially highly purified intrinsic oxide semiconductor layer has an extremely low off-state current; even when an element has a channel width W of 1×10⁶ μm and a channel length L of 10 μm, the off-state current can be less than or equal to the measurement limit of a semiconductor parameter analyzer, i.e., less than or equal to 1×10⁻¹³ A, at a voltage (drain voltage) between a source electrode and a drain electrode in the range from 1 V to 10 V. Thus, the transistors 251, 252, and the like each of whose channel region is formed in the oxide semiconductor layer has a small change in electrical characteristics and is highly reliable. Note that a similar oxide semiconductor layer is preferably used for the transistors 201, 202, 203, and the like that are provided on the second substrate 31 side.

In FIG. 9, a region of the insulating layer 264 overlapping with the first conductive layer 111a serving as the electrode of the capacitor 110 is selectively removed. The insulating layer 265 may be formed in contact with the first conductive layer 111a and then be removed from the upper surface of the first conductive layer 111a. For example, an insulating film containing hydrogen, that is, an insulating film capable of releasing hydrogen, typically, a silicon nitride film, is used as the insulating layer 265, whereby hydrogen can be supplied to the first conductive layer 111a. The insulating film capable of releasing hydrogen preferably has a hydrogen concentration of 1×10²² atoms/cm³ or higher. When such an insulating film is formed in contact with the first conductive layer 111a, it is possible to make the first conductive layer 111a effectively contain hydrogen. In this manner, in combination with the above-described plasma treatment, the structure of the insulating film in contact with the oxide semiconductor layer is changed, whereby the resistance of the oxide semiconductor layer can be appropriately adjusted. Note that a layer including an oxide semiconductor whose resistance is sufficiently reduced can be referred to as an oxide conductor layer.

Hydrogen contained in the first conductive layer 111a reacts with oxygen bonded to a metal atom to be water, and also causes oxygen vacancy in a lattice from which oxygen is released (or a portion from which oxygen is released). Due to entry of hydrogen into the oxygen vacancy, an electron serving as a carrier is generated in some cases. Further, in some cases, bonding of part of hydrogen to oxygen bonded to a metal element causes generation of an electron serving as a carrier. Therefore, the oxide semiconductor included in the first conductive layer 111a containing hydrogen has a higher carrier density than the oxide semiconductor used for the transistors.

The oxide semiconductor included in the first conductive layer 111a serving as the electrode of the capacitor 110 has higher hydrogen concentration and/or more oxygen vacancies than the oxide semiconductor used for the transistors, and the resistance thereof is reduced.

The oxide semiconductor layer used for the first conductive layer 111a and the transistors is typically formed using a metal oxide such as an In—Ga oxide, an In—Zn oxide, or an In-M-Zn oxide (M is Mg, Al, Ti, Ga, Y, Zr, La, Sn, Ce, Nd, or Hf). Note that the oxide semiconductor layer used for the first conductive layer 111a and the transistors has a light-transmitting property.

Note that in the case where the oxide semiconductor layer used for the first conductive layer 111a and the transistors is an In-M-Zn oxide, when the summation of In and M is assumed to be 100 atomic %, the proportions of In and Mare preferably set to be greater than or equal to 25 atomic % and less than 75 atomic %, respectively, or greater than or equal to 34 atomic % and less than 66 atomic %, respectively.

An energy gap of the oxide semiconductor layer used for the first conductive layer 111a and the transistors is preferably 2 eV or more, 2.5 eV or more, or 3 eV or more.

The thickness of the oxide semiconductor layer used for the first conductive layer 111a and the transistors can be greater than or equal to 3 nm and less than or equal to 200 nm, greater than or equal to 3 nm and less than or equal to 100 nm, or greater than or equal to 3 nm and less than or equal to 60 nm.

Further, in the case where the oxide semiconductor layer used for the first conductive layer 111a and the transistors is an In-M-Zn oxide, the atomic ratio of metal elements of a sputtering target used for forming the In-M-Zn oxide preferably satisfies In≧M and Zn≧M. As the atomic ratio of metal elements of such a sputtering target, In:M:Zn=1:1:1, In:M:Zn=1:1:1.2, In:M:Zn=2:1:1.5, In:M:Zn=2:1:2.3, In:M:Zn=2:1:3, In:M:Zn=3:1:2, or the like is preferable. Note that the proportion of each metal element in the atomic ratio of the formed oxide semiconductor layer used for the first conductive layer 111a and the transistors varies within a range of ±40% of that of the corresponding metal in the above atomic ratio of the sputtering target as an error.

When hydrogen is added to an oxide semiconductor in which an oxygen vacancy is generated, hydrogen enters an oxygen vacant site and forms a donor level in the vicinity of the conduction band. As a result, the conductivity of the oxide semiconductor is increased, so that the oxide semiconductor becomes a conductor. An oxide semiconductor having become a conductor can be referred to as an oxide conductor. Oxide semiconductors generally have a visible light transmitting property because of their large energy gap. An oxide conductor is an oxide semiconductor having a donor level in the vicinity of the conduction band. Therefore, the influence of absorption due to the donor level is small, and an oxide conductor has a visible light transmitting property comparable to that of an oxide semiconductor. In other words, the oxide conductor is a degenerate semiconductor and it is suggested that the conduction band edge agrees with or substantially agrees with the Fermi level. Therefore, the oxide conductor film can be used as the electrode of the capacitor, for example.

In the structure shown in FIG. 9, the first conductive layer 111a can be formed at the time of forming the transistors; thus, the manufacturing process can be simplified. In addition, the manufacturing cost can be reduced because a photomask is not necessary for forming the first conductive layer 111a in FIG. 9.

In the structure of FIG. 9, semiconductor films obtained by processing the same semiconductor film can be used as the first conductive layer 111a, the semiconductor layers of the transistors, and the anti-reflection layer 171. In addition, the first conductive layer 111a and the anti-reflection layer 171 may be formed by the same step, or be each subjected to different treatment. In particular, the first conductive layer 111a preferably has a higher light-transmitting property than the anti-reflection layer 171 in order to transmit light from the light-emitting element 204.

The above is the description of the cross-sectional structure example.

Though this embodiment shows the structure including two substrates, i.e., the first substrate supporting the touch sensor and the second substrate supporting the display element, the structure is not limited thereto. For example, a structure with three substrates where a display element is sandwiched between two substrates and the first substrate supporting a touch sensor is bonded thereto can be employed. Alternatively, a structure with four substrates where a display element sandwiched between two substrates and a touch sensor sandwiched between two substrates are bonded to each other can be employed.

### Modification Example

The following shows a structure example of a display device of one embodiment of the present invention.

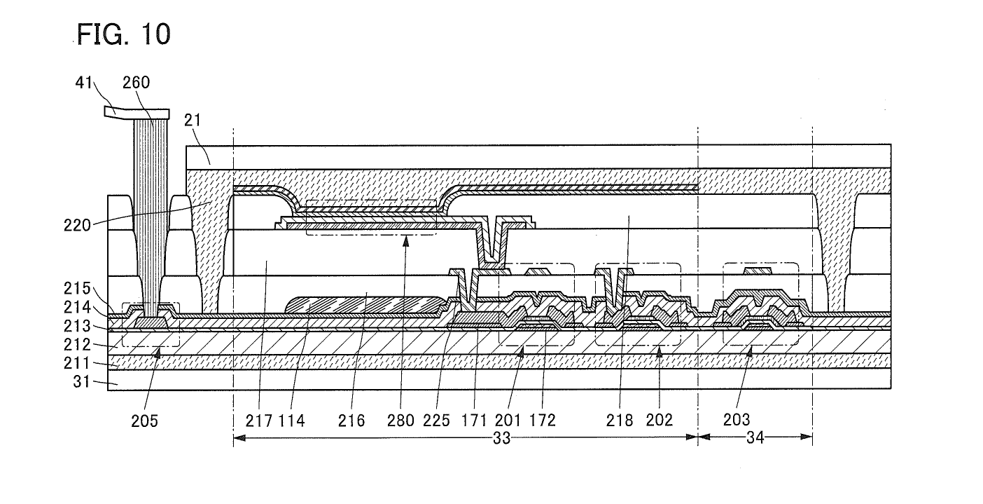

FIG. 10 is a cross-sectional schematic view of a display panel module using a bottom-emission light-emitting element 280. The structure in FIG. 10 is different from the structure in FIGS. 8A and 8B in the structure of transistors, the absence of a touch sensor, the structure of the light-emitting element 280, the position of the coloring layer 114, and the like.

The light-emitting element 280 in FIG. 10 is a bottom-emission light-emitting element emitting light to the second substrate 31 side. Therefore, an image can be displayed on the second substrate 31 side.

The anti-reflection layer 171 is provided between the second substrate 31 and a wiring formed by the same step as that of forming the source and drain electrodes of the transistors 201, 202, and 203. The anti-reflection layer 172 is provided between the second substrate 31 and a wiring formed by the same step as that of forming the gate electrodes of the transistors 201, 202, and 203. Therefore, these wirings are inhibited from being seen from the second substrate 31 side which is a display surface side.

Using such a structure, a display device with high viewability can be obtained since the transistors or the wirings included in circuits are not visible from the display surface side. In addition, as it is not necessary to provide a light-blocking film or the like to make the transistors or the circuits not be seen from the display surface side, the number of components can be reduced and there is no concern that the light-blocking film shields part of a pixel and blocks light therefrom to reduce aperture ratio.

The above is the description of the modification example.

At least part of this embodiment can be implemented in combination with any of the embodiments described in this specification as appropriate.

### Embodiment 3

In this embodiment, a structure example of a touch sensor of one embodiment of the present invention and a driving method thereof is described with reference to drawings.

### Structure Example

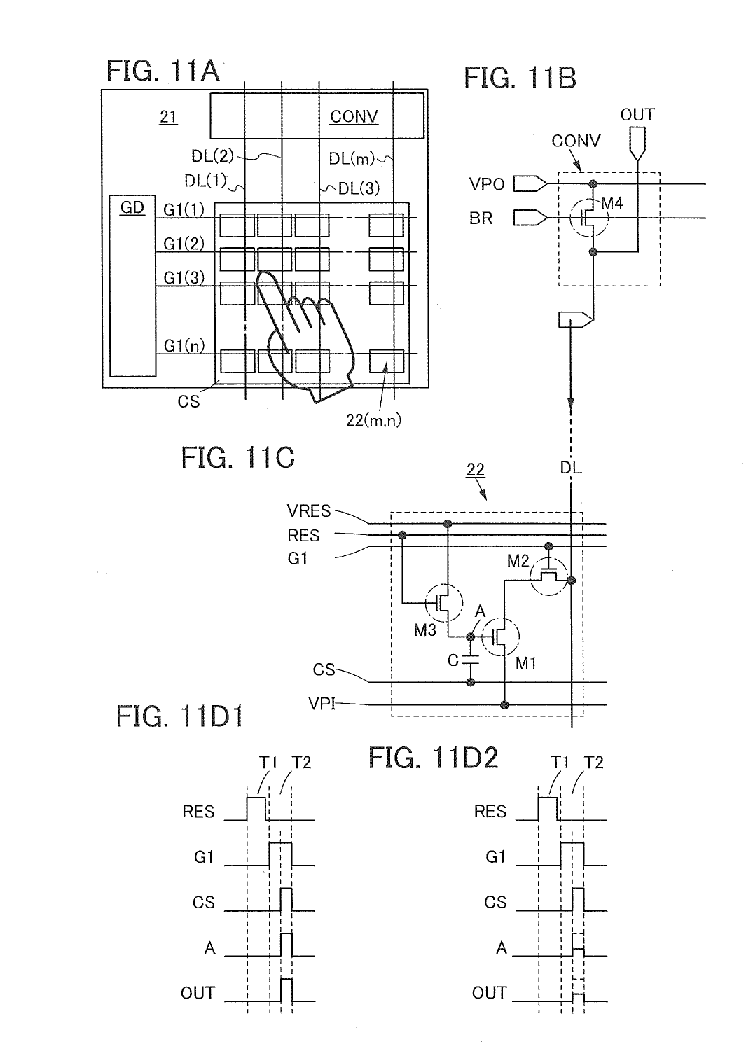

FIG. 11A is a block diagram illustrating a structure of a touch panel (also referred to as an input/output device) of one embodiment of the present invention. FIG. 11B is a circuit diagram illustrating a structure of a converter CONV. FIG. 11C is a circuit diagram illustrating a structure of the sensor element 22. FIG. 11D1 and FIG. 11D2 are timing charts illustrating a driving method of the sensor element 22.

The touch sensor illustrated in this embodiment includes a plurality of sensor elements 22 arranged in a matrix, scan lines G1 electrically connected to the plurality of sensor elements 22 arranged in a row direction, signal lines DL electrically connected to the plurality of sensor elements 22 arranged in a column direction, and the first substrate 21 with flexibility where the sensor elements 22, scan lines G1, and the signal lines DL are provided (see FIG. 11A).

For example, the plurality of sensor elements 22 can be arranged in a matrix of n rows and in columns (n and in are each a natural number larger than or equal to 1).

Note that the sensor element 22 includes a capacitor C serving as a sensing element. The capacitor C corresponds to the capacitor 110 in Embodiment 2. For example, a first electrode and a second electrode of the capacitor C correspond to the first conductive layer 111 and the second conductive layer 113 in Embodiment 2, respectively.

The wiring provided with the anti-reflection layer illustrated in the above embodiment can be used for the signal line DL, the scan line G1, and the like.

The second electrode of the capacitor C is electrically connected to a wiring CS. Accordingly, a potential of the second electrode of the capacitor C can be controlled by a control signal supplied from the wiring CS.

The sensor element 22 of one embodiment of the present invention includes at least a transistor M1. In addition, a transistor M2 and/or a transistor M3 may be included (see FIG. 11C).

A gate of the transistor M1 is electrically connected to the first electrode of the capacitor C, and a first electrode of the transistor M1 is electrically connected to a wiring VPI. The wiring VPI has a function of supplying, for example, a ground potential.

Furthermore, a gate of the transistor M2 is electrically connected to the scan line G1, a first electrode of the transistor M2 is electrically connected to a second electrode of the transistor M1, and a second electrode of the transistor M2 is electrically connected to the signal line DL. The scan line G1 has a function of supplying, for example, a selection signal. The signal line DL has a function of supplying, for example, a sensor signal DATA.

A gate of the transistor M3 is electrically connected to a wiring RES, a first electrode of the transistor M3 is electrically connected to the first electrode of the capacitor C, and a second electrode of the transistor M3 is electrically connected to a wiring VRES. The wiring RES has a function of supplying, for example, a reset signal. The wiring VRES has a function of supplying, for example, a potential at which the transistor M1 can be turned on.

Capacitance of the capacitor C is changed when an object gets closer to the first electrode or the second electrode or when a gap between the first electrode and the second electrode is changed, for example. Thus, the sensor element 22 can supply the sensor signal DATA in accordance with a change in capacitance of the capacitor C.

The wiring CS electrically connected to the second electrode of the capacitor C has a function of supplying a control signal controlling a potential of the second electrode of the capacitor C.

Note that a node at which the first electrode of the capacitor C, the gate of the transistor M1, and the first electrode of the transistor M3 are electrically connected to each other is referred to as a node A.

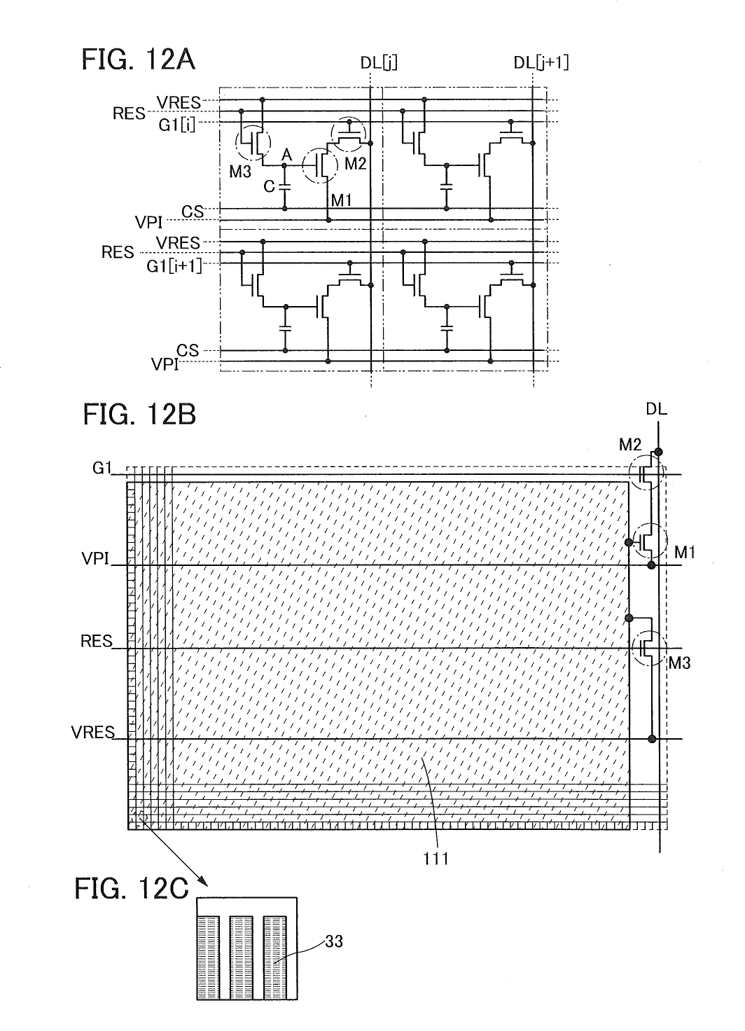

FIG. 12A is an example of a circuit diagram in the case where four sensor elements 22 are arranged in an array of two rows and two columns.

FIG. 12B shows a positional relationship between the first conductive layer 111 (corresponding to the first electrode) included in the sensor element 22 and the wirings. The first conductive layer 111 is electrically connected to the gate of the transistor M1 and the second electrode of the transistor M3. The first conductive layer 111 overlaps with a plurality of pixels 33 shown in FIG. 12C. The transistors M1 to M3 are preferably arranged not to overlap with the first conductive layer 111 as shown in FIG. 12B.

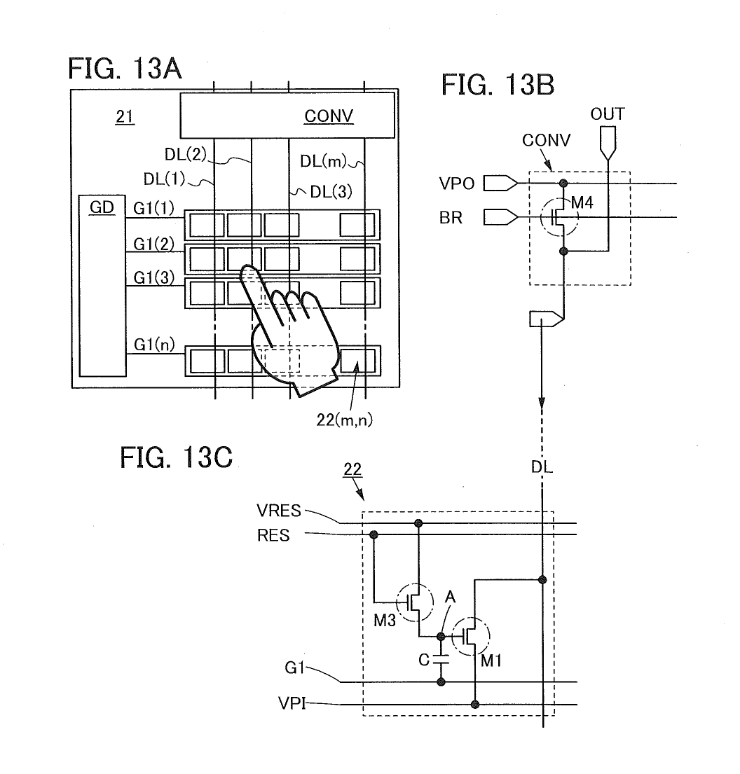

As shown in FIGS. 13A to 13C, the sensor element 22 is not necessarily provided with the transistor M2. In that case, in a plurality of sensor elements 22 arranged in the row direction, the second electrode of each capacitor C may be electrically connected the scan line G1 instead of the wiring CS.

A wiring VPO and a wiring BR shown in FIG. 11B each have a function of supplying, for example, a power source potential high enough to turn on a transistor. The signal line DL has a function of supplying a sensor signal DATA. A terminal OUT has a function of supplying a signal converted based on the sensor signal DATA.

The converter CONV has a conversion circuit. Any of various circuits that can convert the sensor signal DATA and supply the converted signal to the terminal OUT can be used as the converter CONV. For example, a circuit serving as a source follower circuit or a current mirror circuit, which is formed by electrically connecting the converter CONV to the sensor element 22, can be used.

Specifically, a source follower circuit can be formed using the converter CONV including a transistor M4 (see FIG. 11B). Note that a transistor that can be formed in the same process as those of the transistors M1 to M3 may be used as the transistor M4.

For example, the structure of the transistor 251, 252, or the like illustrated in Embodiment 2 may be used for the transistors M1 to M4.

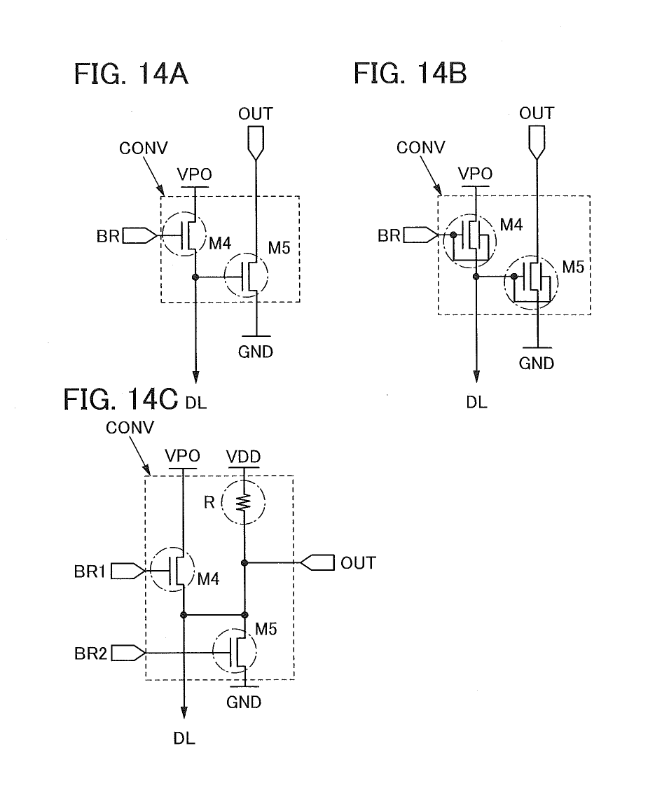

Note that the structure of the converter CONV is not limited to that shown in FIG. 11B. FIGS. 14A to 14C illustrate different examples of the converter CONV.

The converter CONV in FIG. 14A includes a transistor M5 in addition to the transistor M4. Specifically, a gate of the transistor M5 is electrically connected to the signal line DL, a first electrode of the transistor M5 is electrically connected the terminal OUT, and a second electrode of the transistor M5 is electrically connected to a wiring GND. The wiring GND has a function of supplying, for example, a ground potential. As shown in FIG. 14B, the transistors M4 and M5 may each include a second gate. In that case, the second gate is preferably electrically connected to the gate.

The converter CONV in FIG. 14C includes the transistor M4, the transistor M5, and a resistor R. Specifically, the gate of the transistor M4 is electrically connected to a wiring BR1. The gate of the transistor M5 is electrically connected to a wiring BR2, the first electrode of the transistor M5 is electrically connected the terminal OUT and a second electrode of the resistor R, and the second electrode of the transistor M5 is electrically connected the wiring GND. A first electrode of the resistor R is electrically connected a wiring VDD. The wirings BR1 and BR2 each have a function of supplying, for example, a power source potential high enough to turn on a transistor. The wiring VDD has a function of supplying, for example, a high power source potential.

### [Driving Method Example]

Next, the driving method of the sensor element 22 is explained with reference to FIGS. 11A, 11B, 11C, 11D1, and 11D2.

### <First Step>

In a first step, a reset signal for turning on the transistor M3 and subsequently turning off the transistor M3 is supplied to the gate of the transistor M3, and a potential of the first electrode of the capacitor C (that is, a potential of the node A) is set at a predetermined potential (see a period T1 in FIG. 11D1).

Specifically, a reset signal is supplied to the wiring RES. The transistor M3 to which the reset signal is supplied sets the potential of the node A to a potential at which the transistor M1 is turned on, for example.

### <Second Step>

In a second step, a selection signal that turns on the transistor M2 is supplied to the gate of the transistor M2, and the second electrode of the transistor M1 is electrically connected to the signal line DL (see a period T2 in FIG. 11D1).

Specifically, a selection signal is supplied to the scan line G1. Through the transistor M2 to which the selection signal is supplied, the second electrode of the transistor M1 is electrically connected to the signal line DL.

### <Third Step>

In a third step, a control signal is supplied to the second electrode of the capacitor C, and a potential that varies depending on the control signal and the capacitance of the capacitor C is supplied to the gate of the transistor M1.

Specifically, a rectangular control signal is supplied to the wiring CS. By supplying the rectangular control signal to the second electrode of the capacitor C, the potential of the node A is changed based on the capacitance of the capacitor C (see the latter half in the period T2 in FIG. 11D1).

For example, when the capacitor C is placed in the air and an object with a higher dielectric constant than the air comes close to the second electrode of the capacitor C, the apparent capacitance of the capacitor C increases.

Thus, the change in the potential of the node A due to the rectangular control signal becomes smaller than that in the case where an object whose dielectric constant is higher than that of the air is not located closer (see a solid line in FIG. 11D2).

In addition, when a gap between the first electrode and the second electrode of the capacitor C is changed by deformation of the touch panel, the capacitance of the capacitor C is changed. Accordingly, the potential of the node A is changed.

### <Fourth Step>

In a fourth step, a signal obtained by the change in the potential of the gate of the transistor M1 is supplied to the signal line DL.

For example, a change in current due to the change in the potential of the gate of the transistor M1 is supplied to the signal line DL.

The converter CONV converts a change in current flowing through the signal line DL into a voltage change and supplies the voltage change, for example.

### <Fifth Step>

In a fifth step, a selection signal for turning off the transistor M2 is supplied to the gate of the transistor M2.

In this manner, operation of the plurality of sensor elements 22 electrically connected to one scan line G1 is completed.

When there are n scan lines G1, the first step to the fifth step are conducted with respect to each of the scan line G1(1) to the scan line G1(n).

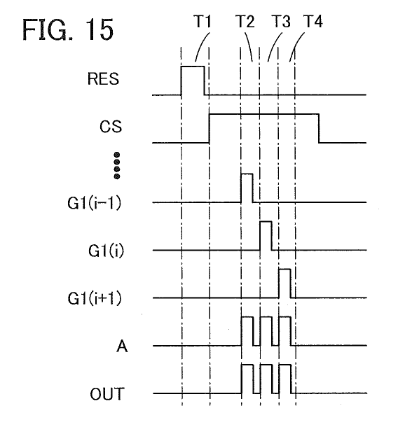

Alternatively, a driving method shown in FIG. 15 may be performed when the wiring RES and the wiring CS are shared by the sensor elements 22. First, the reset signal is supplied to the wiring RES. Next, with the wiring CS supplied with the control signal, the selection signal is sequentially supplied to the scan line G1(1) to the scan line G1(n) so that a signal caused by a potential change of the node A is supplied to the signal line DL(1) to the signal line DL(m).

With such a method, frequency of supply of reset signals and that of control signals can be reduced.

The above is the description of the driving method.

At least part of this embodiment can be implemented in combination with any of the embodiments described in this specification as appropriate.

### Embodiment 4

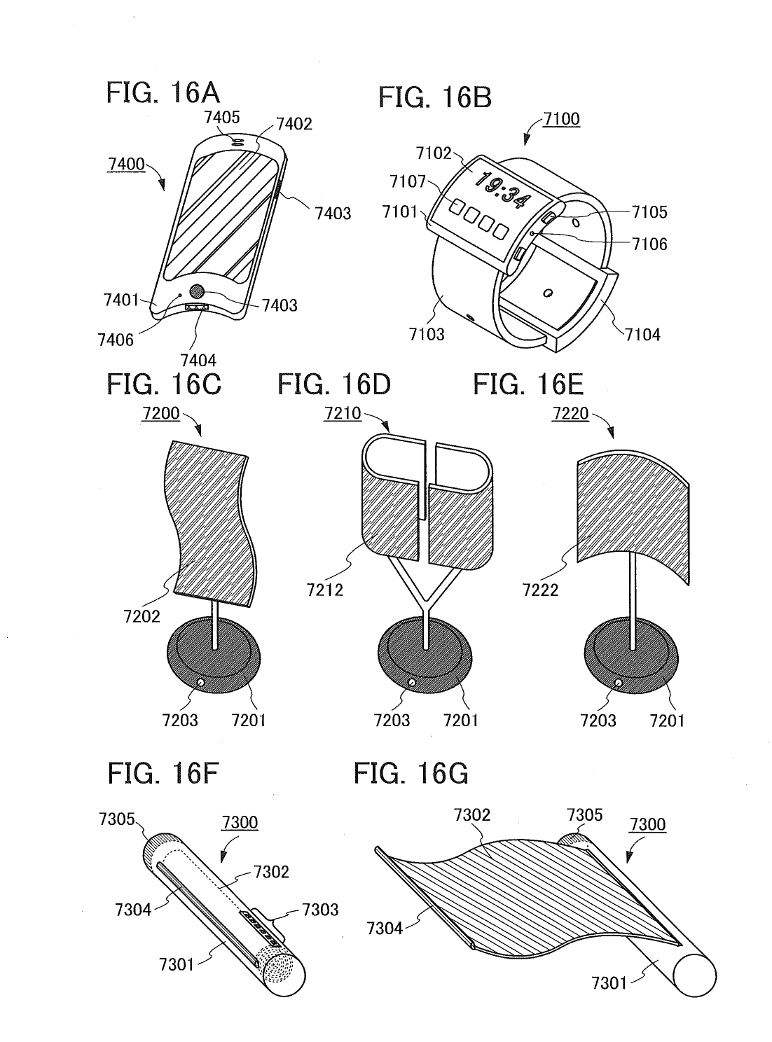

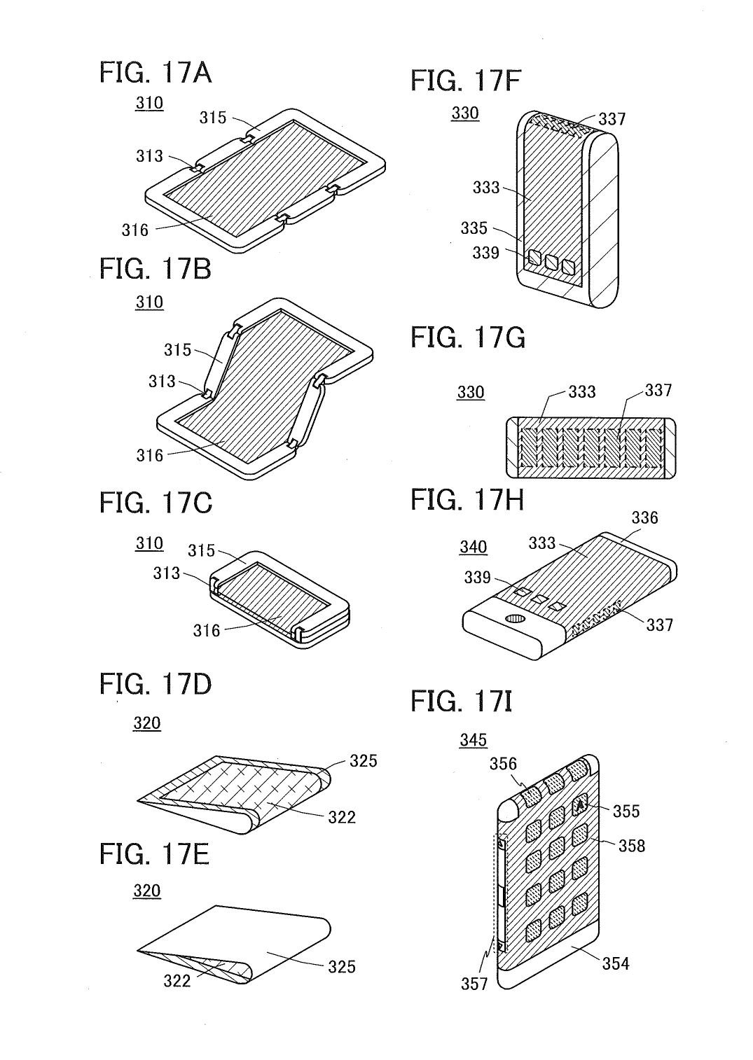

In this embodiment, examples of electronic devices and lighting devices that can be manufactured according to one embodiment of the present invention will be described with reference to FIGS. 16A to 16G and FIGS. 17A to 17I. Note that the following shows the case where a touch panel (or a touch panel module) of one embodiment of the present invention is used for a display portion embedded in a housing, but a display panel (or a display panel module) of one embodiment of the present invention can be used instead. Alternatively, a touch panel where a function as a touch sensor is added to a display panel of one embodiment of the present invention can be used.

A touch panel of one embodiment of the present invention has flexibility. Therefore, the touch panel of one embodiment of the present invention can be used in electronic devices and lighting devices having flexibility. Furthermore, an electronic device or a lighting device having high reliability and high resistance to repeated bending can be manufactured by one embodiment of the present invention.

Examples of electronic devices include a television set (also referred to as a television or a television receiver), a monitor of a computer or the like, a digital camera, a digital video camera, a digital photo frame, a mobile phone (also referred to as a mobile phone device), a portable game machine, a portable information terminal, an audio reproducing device, a large game machine such as a pinball machine, and the like.

A touch panel of one embodiment of the present invention has flexibility and therefore can be incorporated along a curved inside/outside wall surface of a house or a building or a curved interior/exterior surface of a car.

An electronic device of one embodiment of the present invention may include a touch panel and a secondary battery. It is preferable that the secondary battery is capable of being charged by contactless power transmission.

As examples of the secondary battery, a lithium ion secondary battery such as a lithium polymer battery (lithium ion polymer battery) using a gel electrolyte, a lithium ion battery, a nickel-hydride battery, a nickel-cadmium battery, an organic radical battery, a lead-acid battery, an air secondary battery, a nickel-zinc battery, and a silver-zinc battery can be given.

The electronic device of one embodiment of the present invention may include a touch panel and an antenna. Receiving a signal with the antenna enables a display portion to display video, information, and the like. When the electronic device includes a secondary battery, the antenna may be used for contactless power transmission.

FIG. 16A illustrates an example of a mobile phone. The mobile phone 7400 is provided with a display portion 7402 incorporated in a housing 7401, operation buttons 7403, an external connection port 7404, a speaker 7405, a microphone 7406, and the like. The mobile phone 7400 is manufactured using the touch panel of one embodiment of the present invention for the display portion 7402. In accordance with one embodiment of the present invention, a highly reliable cellular phone having a curved display portion can be provided at a high yield.

When the display portion 7402 of the mobile phone 7400 in FIG. 16A is touched with a finger or the like, data can be input into the mobile phone 7400. Further, operations such as making a call and inputting a letter can be performed by touch on the display portion 7402 with a finger or the like.

With the operation buttons 7403, power ON or OFF can be switched. In addition, types of images displayed on the display portion 7402 can be switched; for example, switching images from a mail creation screen to a main menu screen can be conducted.

FIG. 16B illustrates an example of a wrist-watch-type portable information terminal. A portable information terminal 7100 includes a housing 7101, a display portion 7102, a band 7103, a buckle 7104, an operation button 7105, an input/output terminal 7106, and the like.

The portable information terminal 7100 is capable of executing a variety of applications such as mobile phone calls, e-mailing, reading and editing texts, music reproduction, Internet communication, and a computer game.

The display surface of the display portion 7102 is bent, and images can be displayed on the bent display surface. Furthermore, the display portion 7102 includes a touch sensor, and operation can be performed by touching the screen with a finger, a stylus, or the like. For example, by touching an icon 7107 displayed on the display portion 7102, an application can be started.

With the operation button 7105, a variety of functions such as time setting, power ON/OFF, ON/OFF of wireless communication, setting and cancellation of manner mode, and setting and cancellation of power saving mode can be performed. The functions of the operation button 7105 can be set freely by setting the operating system incorporated in the portable information terminal 7100, for example.

The portable information terminal 7100 can employ near field communication that is a communication method based on an existing communication standard. In that case, for example, mutual communication between the portable information terminal 7100 and a headset capable of wireless communication can be performed, and thus hands-free calling is possible.

Moreover, the portable information terminal 7100 includes the input/output terminal 7106, and data can be directly transmitted to and received from another information terminal via a connector. Charging through the input/output terminal 7106 is possible. Note that the charging operation may be performed by wireless power feeding without using the input/output terminal 7106.

The display portion 7102 of the portable information terminal 7100 includes the touch panel of one embodiment of the present invention. According to one embodiment of the present invention, a highly reliable portable information terminal having a curved display portion can be provided at a high yield.

FIGS. 16C to 16E illustrate examples of lighting devices. Lighting devices 7200, 7210, and 7220 each include a stage 7201 provided with an operation switch 7203 and a light-emitting portion supported by the stage 7201.

The lighting device 7200 shown in FIG. 16C includes a light-emitting portion 7202 with a waved light-emitting surface, and thus is a lighting device with high designability.

A light-emitting portion 7212 included in the lighting device 7210 illustrated in FIG. 16D has two convex-curved light-emitting portions symmetrically placed. Thus, all directions can be illuminated with the lighting device 7210 as a center.

The lighting device 7220 illustrated in FIG. 16E includes a concave-curved light-emitting portion 7222. This is suitable for illuminating a specific range because light emitted from the light-emitting portion 7222 is collected to the front of the lighting device 7220.

The light-emitting portion included in each of the lighting devices 7200, 7210, and 7220 are flexible; thus, the light-emitting portion may be fixed on a plastic member, a movable frame, or the like so that an emission surface of the light-emitting portion can be bent freely depending on the intended use.

Note that although the lighting device in which the light-emitting portion is supported by the stage is described as an example here, a housing provided with a light-emitting portion can be fixed on a ceiling or suspended from a ceiling. Since the light-emitting surface can be curved, the light-emitting surface is curved to have a depressed shape, whereby a particular region can be brightly illuminated, or the light-emitting surface is curved to have a projecting shape, whereby a whole room can be brightly illuminated.

Here, each of the light-emitting portions includes the touch panel of one embodiment of the present invention. In accordance with one embodiment of the present invention, a highly reliable lighting device having a curved light-emitting portion can be provided at a high yield.

FIG. 16F illustrates an example of a portable touch panel. A touch panel 7300 includes a housing 7301, a display portion 7302, operation buttons 7303, a display portion pull 7304, and a control portion 7305.

The touch panel 7300 includes a rolled flexible display portion 7302 in the cylindrical housing 7301.

The touch panel 7300 can receive a video signal with the control portion 7305 and can display the received video on the display portion 7302. In addition, a battery is included in the control portion 7305. Moreover, a terminal portion for connecting a connector may be included in the control portion 7305 so that a video signal or power can be directly supplied from the outside with a wiring.

By pressing the operation buttons 7303, power ON/OFF, switching of displayed videos, and the like can be performed.

FIG. 16G illustrates the touch panel 7300 in a state where the display portion 7302 is pulled out with the display portion pull 7304. Videos can be displayed on the display portion 7302 in this state. Further, the operation buttons 7303 on the surface of the housing 7301 allow one-handed operation. The operation buttons 7303 are provided not in the center of the housing 7301 but on one side of the housing 7301 as illustrated in FIG. 16F, which makes one-handed operation easy.

Note that a reinforcement frame may be provided for a side portion of the display portion 7302 so that the display portion 7302 has a flat display surface when pulled out.

Note that in addition to this structure, a speaker may be provided for the housing so that sound is output with an audio signal received together with a video signal.

The display portion 7302 includes the touch panel of one embodiment of the present invention. According to one embodiment of the present invention, a lightweight and highly reliable touch panel can be provided at a high yield.

FIGS. 17A to 17C illustrate a foldable portable information terminal 310. FIG. 17A illustrates the portable information terminal 310 that is opened. FIG. 17B illustrates the portable information terminal 310 that is being opened or being folded. FIG. 17C illustrates the portable information terminal 310 that is folded. The portable information terminal 310 is highly portable when folded. When the portable information terminal 310 is opened, a seamless large display region is highly browsable.

A display panel 316 is supported by three housings 315 joined together by hinges 313. By folding the portable information terminal 310 at a connection portion between two housings 315 with the hinges 313, the portable information terminal 310 can be reversibly changed in shape from an opened state to a folded state. The touch panel according to one embodiment of the present invention can be used for the display panel 316. For example, it is possible to use a touch panel that can be bent with a radius of curvature of 1 mm or more and 150 mm or less.

In one embodiment of the present invention, a sensor that senses whether the touch panel is folded or opened and supplies sensing information may be provided. The operation of a folded portion (or a portion that becomes invisible from a user by folding) of the touch panel may be stopped by a control device through the acquisition of data indicating the folded state of the touch panel. Specifically, display of the portion may be stopped, and furthermore, sensing by the touch sensor may be stopped.

The control unit of the touch panel may make display and sensing by a touch sensor restart when obtaining information indicating that the touch panel is opened.

FIGS. 17D and 17E each illustrate a foldable portable information terminal 320. FIG. 17D illustrates the portable information terminal 320 that is folded so that a display portion 322 is on the outside. FIG. 17E illustrates the portable information terminal 320 that is folded so that the display portion 322 is on the inside. When the portable information terminal 320 is not used, the portable information terminal 320 is folded so that a non-display portion 325 faces the outside, whereby the display portion 322 can be prevented from being contaminated or damaged. The touch panel in one embodiment of the present invention can be used for the display portion 322.

FIG. 17F is a perspective view illustrating an external shape of a portable information terminal 330. FIG. 17G is a top view of the portable information terminal 330. FIG. 17H is a perspective view illustrating an external shape of a portable information terminal 340.

The portable information terminals 330 and 340 each function as, for example, one or more of a telephone set, a notebook, and an information browsing system. Specifically, the portable information terminals 330 and 340 each can be used as a smartphone.

The portable information terminals 330 and 340 can display characters and image information on its plurality of surfaces. For example, three operation buttons 339 can be displayed on one surface (FIGS. 17F and 17H). In addition, information 337 indicated by dashed rectangles can be displayed on another surface (FIGS. 17G and 17H). Examples of the information 337 include notification from a social networking service (SNS), display indicating reception of an e-mail or an incoming call, the title of an e-mail or the like, the sender of an e-mail or the like, the date, the time, remaining battery, and the reception strength of an antenna. Alternatively, the operation buttons 339, an icon, or the like may be displayed in place of the information 337. Although FIGS. 17F and 17G illustrate an example in which the information 337 is displayed at the top, one embodiment of the present invention is not limited thereto. The information may be displayed on the side, for example, as illustrated in FIG. 17H.

For example, a user of the portable information terminal 330 can see the display (here, the information 337) with the portable information terminal 330 put in a breast pocket of his/her clothes.

Specifically, a caller's phone number, name, or the like of an incoming call is displayed in a position that can be seen from above the portable information terminal 330. Thus, the user can see the display without taking out the portable information terminal 330 from the pocket and decide whether to answer the call.

The touch panel of one embodiment of the present invention can be used for a display portion 333 mounted in each of a housing 335 of the portable information terminal 330 and a housing 336 of the portable information terminal 340. According to one embodiment of the present invention, a highly reliable touch panel having a curved display portion can be provided at a high yield.

Information may be displayed on three or more sides as shown by a portable information terminal 345 illustrated in FIG. 17I. Here, data 355, data 356, and data 357 are displayed on different sides.

The touch panel of one embodiment of the present invention can be used for a display portion 358 included in a housing 354 of the portable information terminal 345. According to one embodiment of the present invention, a highly reliable touch panel having a curved display portion can be provided at a high yield.

At least part of this embodiment can be implemented in combination with any of the embodiments described in this specification as appropriate.

### Example

In this example, measurement results of optical characteristics of an oxide semiconductor film are explained.

### [Fabrication of Samples]

First, as an oxide semiconductor film, an In—Ga—Zn oxide film (hereinafter also referred to as an IGZO film) with a thickness of approximately 100 nm was formed over a quartz substrate by a sputtering method. Note that the IGZO film was formed by a DC sputtering method with a sputtering target of IGZO containing In, Ga, and Zn at an atomic ratio of 1:1:1 (In:Ga:Zn) and a mixed gas containing Ar and O₂ at a flow rate ratio of 3:7 (Ar:O₂) as a deposition gas.

Next, Sample 1 and Sample 2 where plasma treatment was performed on the formed IGZO films, and a reference sample on which plasma treatment was not performed, were prepared.

### <Sample 1>

Plasma treatment was pet-formed on the substrate with the formed IGZO film in an atmosphere containing argon to make Sample 1. The plasma treatment was performed for 300 seconds under a condition where the flow rate of argon was 2000 sccm, the pressure was 200 Pa, the power was 1000 W, and the substrate temperature was 350° C.

### <Sample 2>

Plasma treatment was performed on the substrate with the formed IGZO film in an atmosphere including argon and hydrogen to make Sample 2. The plasma treatment was performed for 300 seconds under a condition where the flow rates of argon and hydrogen were each 2000 sccm, the pressure was 200 Pa, the power is 1000 W, and the substrate temperature was 350° C.

### [Measurement of Transmittance and Results]

The transmittance of Sample 1, Sample 2, and the reference sample with respect to a wavelength of incident light was measured. The measurement was conducted with light in a wavelength range of 300 nm to 800 nm incident on each sample.

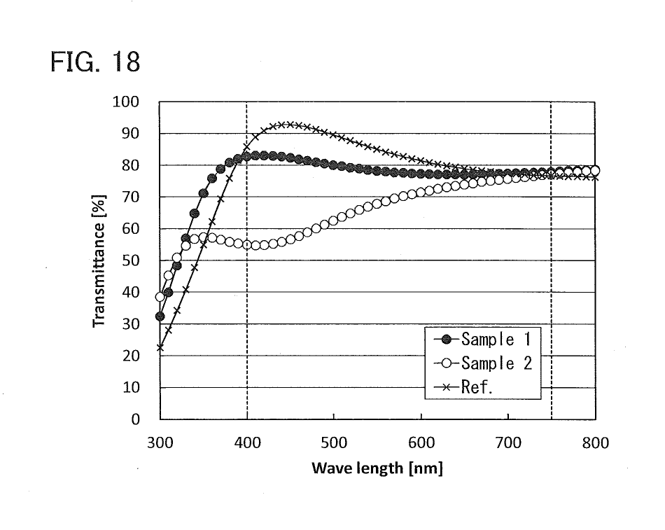

FIG. 18 shows measurement results of transmittance of Sample 1, Sample 2, and the reference sample. In FIG. 18, the horizontal axis represents light wavelengths, and the vertical axis represents transmittance.

It was found that the transmittance of Sample 1 and that of Sample 2 were each lower than that of the reference sample in a wavelength range less than or equal to 700 nm. That is, it was found that optical characteristics of the oxide semiconductor films were changed by the plasma treatment.

In a wavelength range of 300 nm to 400 nm, the curves of transmittance of Sample 1 and Sample 2 that were subjected to the plasma treatment were seemingly shifted to the short wavelength side, compared to the curve of the reference sample. It is estimated that the shift occurs because surface roughness of the oxide semiconductor films was increased by the plasma treatment and the surface unevenness caused light interference.

Comparing Sample 1 and Sample 2, it was found that the transmittance of Sample 2 was more significantly lowered than Sample 1. Thus, it can be said that the transmittance can be more lowered by performing plasma treatment in an atmosphere containing both argon and hydrogen.

From the above results, it was found that transmittance of an oxide semiconductor film could be lowered by plasma treatment on the oxide semiconductor film. The oxide semiconductor film on which such treatment has been performed can be favorably used as an anti-reflection layer of one embodiment of the present invention.

This application is based on Japanese Patent Application serial no. 2014-095101 filed with Japan Patent Office on May 2, 2014, the entire contents of which are hereby incorporated by reference.

What is claimed is:

1. A semiconductor device comprising:
a transistor over a substrate;
a wiring over the substrate; and
a first layer over the substrate,
wherein the substrate transmits visible light,
wherein the transistor comprises a gate electrode, a semiconductor layer, a first electrode, and a second electrode,
wherein the wiring is electrically connected to the gate electrode, the first electrode, or the second electrode,
wherein the first layer is closer to the substrate than the wiring is,
wherein the first layer and the wiring overlap with each other in a region, and
wherein the first layer comprises an oxide semiconductor.

2. The semiconductor device according to claim 1,
wherein the semiconductor layer comprises an oxide semiconductor.

3. The semiconductor device according to claim 1,
wherein the first layer comprises a region where transmittance with respect to light with a wavelength within a range of 400 nm to 750 nm is lower than in the semiconductor layer.

4. The semiconductor device according to claim 1,
wherein the first layer comprises a region with conductivity higher than that of the semiconductor layer.

5. A touch sensor comprising:
the semiconductor device according to claim 1; and
a capacitor electrically connected to the transistor.

6. A touch panel comprising:
the touch sensor according to claim 5; and
a display panel.

7. A display device comprising:
the semiconductor device according to claim 1; and
a display element electrically connected to the transistor.

8. The display device according to claim 7,
wherein the display element comprises a light-emitting element, and
wherein the light emitting element is configured to emit light to the substrate side.

9. A touch panel module comprising:
the touch panel according to claim 6; and
an FPC.

10. A display panel module comprising:
the display device according to claim 7; and
an FPC.

11. An electronic device comprising:
the touch panel module according to claim 9; and
a housing,
wherein the touch panel module is embedded in the housing.

12. An electronic device comprising:
the display panel module according to claim 10; and
a housing,
wherein the display panel module is embedded in the housing.
